(19) United States
(12) Patent Application Publication
(10) Pub. No.: US 2025/0285151 A1
(43) Pub. Date: Sep. 11, 2025

(54) Computer-Automated Integration with Web-Based Accounting Systems for Improved Display and Processing of Invoices

(71) Applicant: Skyline Payment Systems, LLC, San Francisco, CA (US)

(72) Inventors: Phong Quang Le, Oakland, CA (US); Long Quang Le, Oakland, CA (US)

(73) Assignee: Skyline Payment Systems, LLC, San Francisco, CA (US)

(21) Appl. No.: 18/936,734

(22) Filed: Nov. 4, 2024

Related U.S. Application Data
(63) Continuation-in-part of application No. 18/810,343, filed on Aug. 20, 2024.
Application No. 18/810,343 is a continuation-in-part of application No. 18/596,943, filed on Mar. 6, 2024, now Pat. No. 12,100,057.

(51) Int. Cl. G06Q 30/04

(52) U.S. Cl. CPC G06Q 30/04

(57) ABSTRACT

A computer-implemented method and system manages and processes outstanding bills within various accounting software applications. The method includes analyzing a web page to identify a unique bill identifier (e.g., within the web page's URL or a user interface element of the web page), obtaining additional bill information from the accounting system based on the unique bill identifier, and displaying this information in a user-friendly interface. A web browser plugin facilitates real-time data synchronization and payment processing by interacting with the accounting system through an API. The system streamlines the payment process by reducing the number of steps required, improving the efficiency and accuracy of financial transactions. The system is designed to be compatible with multiple accounting systems and web browsers, ensuring broad applicability and ease of use.

### CROSS-REFERENCE TO RELATED APPLICATIONS

The application is a continuation-in-part of U.S. patent application Ser. No. 18/810,343, filed on Aug. 20, 2024, entitled, “Computer-Automated Integration with Web-Based Accounting Systems for Improved Display and Processing of Invoices,” which is a continuation-in-part of U.S. patent application Ser. No. 18/596,943, filed on Mar. 6, 2024, entitled, “Computer-Automated Integration with Web-Based Accounting Systems for Improved Display and Processing of Invoices,” now U.S. Pat. No. 12,100,057, issued on Sep. 24, 2024, all of which are hereby incorporated by reference herein.

### BACKGROUND

The current state of the art in accounting systems involves various software applications designed to manage financial transactions, including the tracking and processing of outstanding invoices. These systems are integral to businesses as they provide a means to oversee accounts receivable and payable, ensuring that invoices are paid and received in a timely manner.

Typically, users (including both vendors and their customers) must navigate through multiple steps within these accounting systems to access detailed information about each outstanding invoice. For example, from the vendor's perspective, this process often involves logging into the vendor's account in the accounting system, navigating to the accounts receivable section, selecting individual invoices, and then reviewing the details of each invoice separately. The information about each invoice is usually displayed in a standardized format within the system, and users must manually search for specific details relevant to their needs, which may be distributed across multiple parts of the system.

When it comes to processing payments for these invoices by customers, vendors are again required to engage in a multi-step procedure. This usually includes selecting the invoice for payment, entering or confirming payment details, and authorizing the transaction. The process can be time-consuming, especially when dealing with a large number of invoices or when the user is required to process payments for multiple customers.

What is needed, therefore, are more efficient methods for processing payments against outstanding invoices in accounting systems.

### SUMMARY

A computer-implemented method and system manages and processes outstanding bills within various accounting software applications. The method includes analyzing a web page to identify a unique bill identifier (e.g., within the web page's URL or a user interface element of the web page), obtaining additional information based on the unique bill identifier, such as additional bill information from the accounting system and payment method data, and displaying this information in a user-friendly interface. A web browser plugin facilitates real-time data synchronization and payment processing by interacting with the accounting system through an API. The system streamlines the payment process by reducing the number of steps required, improving the efficiency and accuracy of financial transactions. The system is designed to be compatible with multiple accounting systems and web browsers, ensuring broad applicability and ease of use.

Other features and advantages of various aspects and embodiments of the present invention will become apparent from the following description and from the claims.

### BRIEF DESCRIPTION OF THE DRAWINGS

FIG. 1 is a diagram of a system for processing a payment of a single customer invoice according to one embodiment of the present invention.

FIG. 2A is a flowchart of a method performed by the system of FIG. 1 to process a single invoice according to one embodiment of the present invention.

FIG. 2B is a flowchart of a method performed by the system of FIG. 1 to process one or more invoices of a customer according to one embodiment of the present invention.

FIGS. 3A-3K are illustrations of user interfaces implemented according to embodiments of the present invention which process invoice payments on behalf of vendors.

FIG. 4 is a diagram of a system for processing a payment of a single customer bill according to one embodiment of the present invention.

FIG. 5A is a flowchart of a method performed by the system of FIG. 4 to process a single bill according to one embodiment of the present invention.

FIG. 5B is a flowchart of a method performed by the system of FIG. 1 to process one or more bills of a customer according to one embodiment of the present invention.

FIGS. 6A-6C are illustrations of user interfaces implemented according to embodiments of the present invention which process bill payments on behalf of customers.

### DETAILED DESCRIPTION

In the realm of financial management, particularly within the scope of accounting practices, the efficient handling of accounts receivable stands as a critical business function. The ability to effectively manage and process outstanding invoices is paramount for maintaining cash flow and ensuring the financial health of an organization. However, the traditional methods employed by existing accounting systems to display and process these invoices are often cumbersome and fragmented, requiring users to engage in a series of repetitive, inefficient, and time-consuming steps.

One motivation for the present invention arises from the recognized need for a more streamlined approach to invoice management, especially on the vendor side in the context of managing and processing payments against open invoices in the vendor's accounts receivable system. Because managing and processing payments against such invoices is such a critical and common task, any increased efficiency in processing such payments stands to significantly reduce the cognitive load and manual effort required to manage accounts receivable. Embodiments of the present invention aim to address the inefficiencies of current systems by introducing features that simplify the user experience and enhance the overall process of managing outstanding invoices.

Embodiments of the invention include a novel method for displaying information about outstanding invoices and processing their payments within digital accounting systems. It leverages technological advancements to provide users with a unified interface that aggregates all pertinent invoice details in a single, easily accessible user interface. This approach not only saves time but also minimizes the potential for errors that can occur when handling multiple invoices across various platforms.

Furthermore, embodiments of the present invention are designed to be versatile, offering compatibility with a wide array of accounting systems. This interoperability ensures that users can enjoy a consistent and simplified experience regardless of the underlying accounting platform they are utilizing. By focusing on user-centric design principles, embodiments of the present invention aim to transform the way users interact with accounting systems, making the process more intuitive and less labor-intensive.

In essence, embodiments of the present invention set out to significantly increase the efficiency of accounts receivable payment processing by providing a solution that is both highly automated and user-friendly. It promises to deliver significant benefits to users, including time savings, reduced complexity, and an overall improvement in the workflow associated with financial transactions.

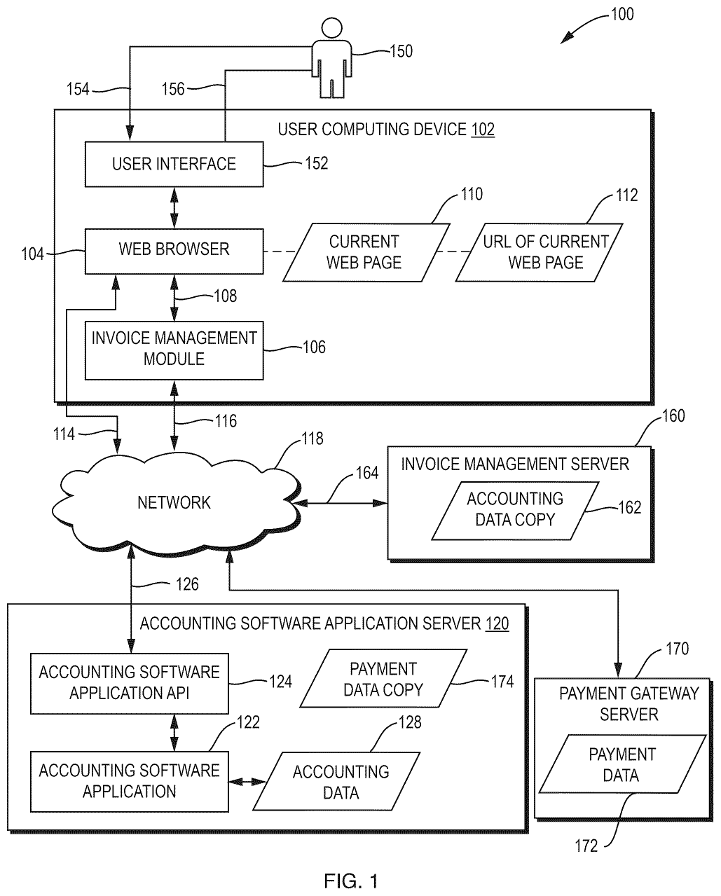

Referring to FIG. 1, a diagram is shown of a system 100 for processing a payment of a single customer invoice according to one embodiment of the present invention. The system 100 includes a user 150 and a computing device 102 of the user 150, also referred to herein as the user computing device 102. The user computing device 102 may be any type of computing device, such as a desktop computer, laptop computer, tablet computer, or smartphone. Although the description herein describes the user computing device 102 as performing a variety of functions, in practice the user 150 may use one or more computing devices to perform the functions disclosed herein.

The system 100 also includes a web browser 104, which may execute on the user computing device 102 and perform any of the conventional functions associated with a web browser. For example, the web browser 104 may interact with one or more web servers over a network 118 to retrieve and display web page content.

The web browser 104 may include a user interface 152, which may receive input 154 from the user 150 and provide output 156 to the user 150 in any of the conventional ways associated with a web browser. For example, the input 154 may specify a URL 112 of a web page to which the user 150 wishes to navigate, in response to which the web browser 104 may navigate to the web page specified by that URL and display that web page as a current web page 110. The web browser 104 may use the user interface 152 to render the current web page 110 and display the resulting rendered web page in the output 156 to the user 150. These are merely high-level examples of conventional ways in which the web browser 104 may operate. More generally, the web browser 104 may perform any of the conventional functions of a web browser. As this implies, the user interface 152 may perform any of the conventional functions of a web browser user interface, and the input 154 and output 156 may be any of the conventional kinds of inputs and outputs known to be input to and output by a web browser user interface.

The system 100 may also include an invoice management module 106. In general, and as will be described in more detail herein, the invoice management module 106 may perform a variety of functions relating to invoices, such as obtaining information about outstanding invoices, outputting such invoice information to the user 150, and processing payments of such invoices. As will further be described in more detail herein, the invoice management module 106 may engage in a variety of communications 108 with the web browser 104 to perform the functions disclosed herein.

The invoice management module 106 may, for example, be implemented as a plugin, extension, or other kind of add-on to the web browser 104. This is merely an example however, and does not constitute a limitation of the present invention. More generally, the invoice management module 106 may be implemented in any manner, such as a standalone application, as an integrated feature within the web browser 104, as a server-side application, or any combination thereof.

The system 100 also includes an accounting software application server 120, which may contain or otherwise host or act as a server for an accounting software application 122. The accounting software application 122 may, for example, be installed on and execute on the accounting software application server 120. In general, the accounting software application 122 may be a software application that manages accounting data 128, including maintaining and processing payments against outstanding invoices. The accounting software application 122 may, for example, be any of a variety of conventional network-accessible (e.g., web-based) accounting software applications, such as QuickBooks online, Freshbooks, or Netsuite.

The accounting software application 122 may interact with clients, such as the web browser 104 and the invoice management module 106 over the network 118 via an accounting software Application Program Interface (API) 124, which is shown as transmitting and receiving various communications 126 over the network 118 with one or more clients. For example, and as will be described in more detail below, the web browser 104 may transmit and receive various communications 114 to and from the accounting software application 122 over the network 118 via the accounting software application API 124. Similarly, and as will be described in more detail below, the web browser 104 may transmit and receive various communications 116 to and from the accounting software application 122 over the network 118 via the accounting software application API 124.

Before describing ways in which the system 100 may retrieve and display invoice information, and ways in which the system 100 may process invoice payments, a process for onboarding the user 150 (or an entity associated with the user 150, such as a vendor) will now be described. Although this onboarding process is not a requirement of the present invention, the onboarding process may be useful to enable embodiments of the present invention to operate more efficiently. In general, and as will now be described in more detail, the onboarding process involves several steps that prepare the components of the system 100 to work together seamlessly.

As part of the onboarding process, the invoice management module 106 may be installed in the system 100. If, for example, the invoice management module 106 is implemented as a plugin to the web browser 104, the plugin may be installed in the web browser 104. The invoice management module 106 may be configured with and store a variety of information, such as any one or more of the following: information identifying the accounting software application 122 (e.g., a name and/or other identifier of the accounting software application 122 to indicate the brand, version, and/or name of the accounting software application 122), information identifying the user 150 (e.g., account information of the user 150 with the invoice management module 106), and information associated with an account of the user 150 with the accounting software application server 120 and/or the accounting software application 122 (e.g., login credentials of the user 150 with the accounting software application server 120 and/or the accounting software application 122). The invoice management module 106 may receive and store any such information for future use.

The user 150 may have an account with the accounting software application server 120 and/or with the accounting software application 122. For ease of explanation, the following description will refer to an account of the user 150 with the accounting software application 122. Such an account, however, should be understood to be an account of the user 150 with either or both of the accounting software application server 120 and the accounting software application 122.

As previously mentioned, the user 150 may, for example, be associated with an entity, such as a vendor. Such an entity (e.g., vendor) may have an account with the accounting software application 122. The user 150 may be one of multiple users who are authorized to access the accounting software application server 120 and the accounting software application 122 on behalf of the vendor. Although the description herein refers to an account of the user 150 with the accounting software application 122, such an account should be understood to be an account of the user 150 and/or an account of an entity (e.g., vendor) with which the user 150 is associated.

Once the invoice management module 106 has been configured, the invoice management module 106 may make an initial connection to the account of the user 150 in the accounting software application 122, such as by logging in to the accounting software application 122 using the credentials of the user 150 with the accounting software application 122 that were previously received by the invoice management module 106. More generally, the invoice management module 106 may automatically establish and maintain such a connection on behalf of the user 150 whenever the invoice management module 106 executes.

During the onboarding process, the invoice management module 106 may obtain a variety of information from the accounting data 128 of the user 150 in the accounting software application 122. Account information which the invoice management module 106 may extract from the user 150's accounting data 128 with the accounting software application 122 may include any one or more of the following: information about the user 150, information about the user 150's customers, and information about invoices (e.g., open invoices) of the user 150's customers within the accounts receivable section of the user 150's accounting data 128. The invoice management module 106 may obtain such information via suitable interactions with the accounting software application 122, such as by making calls to the accounting software application API 124 over the network 118 and receiving responses to such calls over the network 118 (within communications 116 and communications 126).

The invoice management module 106 may store (e.g., on the computing device 102 and/or in one or more storage devices coupled to the computing device 102) any such information from the user 150's account for future use, so that the invoice management module 106 has immediate access to relevant data when performing the functions described herein, without needing to retrieve such information from the accounting software application 122 at runtime. The invoice management module 106 may, however, update its local copy of any such information by obtaining updated information from the accounting software application 122, using any suitable synchronization method. The invoice management module 106 may thereby obtain the benefits of directly accessing locally-stored account information of the user 150 (e.g., avoiding the overhead associated with repeatedly obtaining such information over the 118), without sacrificing accuracy in the event that the user 150's accounting data 128 is updated.

In addition, the system may include an invoice management server 160. In general, the invoice management server 160 may (e.g., during the onboarding process) obtain, from the accounting software application 122, any of a variety of information from the accounting data 128 of the user 150, such as any of the data that the invoice management module 106 is described above as obtaining from the accounting software application 122. The invoice management server 160 may store such obtained data in what is referred to herein as an accounting data copy 162. The invoice management server 160 may obtain such information via suitable interactions 164 with the accounting software application 122, such as by making calls to the accounting software application API 124 over the network 118 and receiving responses to such calls over the network 118.

The invoice management server 160 may serve as an intermediary data repository and processing hub that interfaces with the user 150's local invoice management module 106. The invoice management server 160 may copy and cache, in the accounting data copy 162, a subset or the entirety of the user 150's accounting data 128. This process may include a one-time or periodic synchronization over the network 118, ensuring that the invoice management server 160 maintains an up-to-date replica of some or all of the user 150's accounting data 128. By doing so, the invoice management server 160 provides an easily-accessible access point for the invoice management module 106, reducing the need for frequent direct data retrieval from the accounting software application 122.

Optionally, the system 100 may include one or more payment gateway servers 170, each containing payment data 172. The payment data 172 may include customer payment method information, such as credit card details or ACH information. The invoice management server 160 may communicate with these payment gateway servers 170 to process payments, store, and tokenize payment data, instead of relying on the accounting software application server 120 for these functions.

When processing a payment, the invoice management module 106 may first interact with the appropriate payment gateway server 170 to process the transaction. Upon receiving the transaction results, the invoice management module 106 then communicates with the accounting software application Server 120 to record the transaction in the accounting data 128.

The invoice management server 160 may maintain a payment data copy 174 or references to stored and historical payment data, allowing for efficient access to payment information while maintaining security of sensitive data. This optional configuration allows the system 100 to leverage specialized payment processing services while maintaining integration with the accounting software application for record-keeping purposes.

When the invoice management module 106 requires access to the user 150's accounting data 128, the invoice management module 106 may send a request to the invoice management server 160, instead of to the accounting software application 122. The invoice management server 160 may process such requests by retrieving the necessary data from the accounting data copy 162 and providing the retrieved data to the invoice management module 106. This approach may minimize latency and network load by avoiding direct queries to the accounting software application 122 for each data access operation. By offloading data storage and retrieval tasks to the invoice management server 160, the system 100 may minimize the computational burden on the user computing device 102. This may result in faster response times and a more fluid user experience, as the invoice management module 106 can access cached data from the accounting data copy 162 with minimal delay.

More generally, any read or write request from the invoice management module 106 may be directed to any one or more of the following: data stored locally by the invoice management module 106 or otherwise by the user computing device 102; the invoice management server 160; or the accounting software application 122. Those having ordinary skills will understand how to implement various embodiments of the system 100 to process such read and write requests from any of these stores of data, based on design choices involving tradeoffs between local and remote storage, network latency, and other factors. As a result, any reference herein to the invoice management module 106 requesting, reading, writing, or otherwise accessing the accounting data 128 should be understood to encompass embodiments in which such access is performed by accessing the accounting data 128 itself at the accounting software application server 120, by accessing the accounting data copy 162, by accessing a copy of the accounting data 128 that is stored locally by the invoice management module 106, or any suitable combination thereof.

In general, by performing this onboarding process, the invoice management module 106 ensures that it is ready to perform its functions efficiently. For example, by performing this onboarding process, the invoice management module 106 can avoid the need to request account information from the user 150 multiple times, and can also avoid the need to download the user 150's accounting data 128 more frequently than necessary.

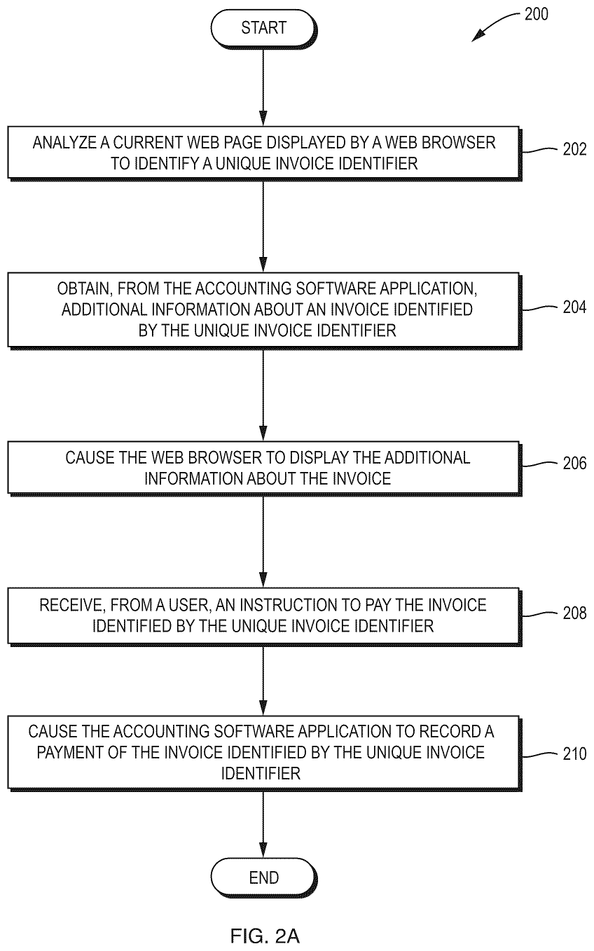

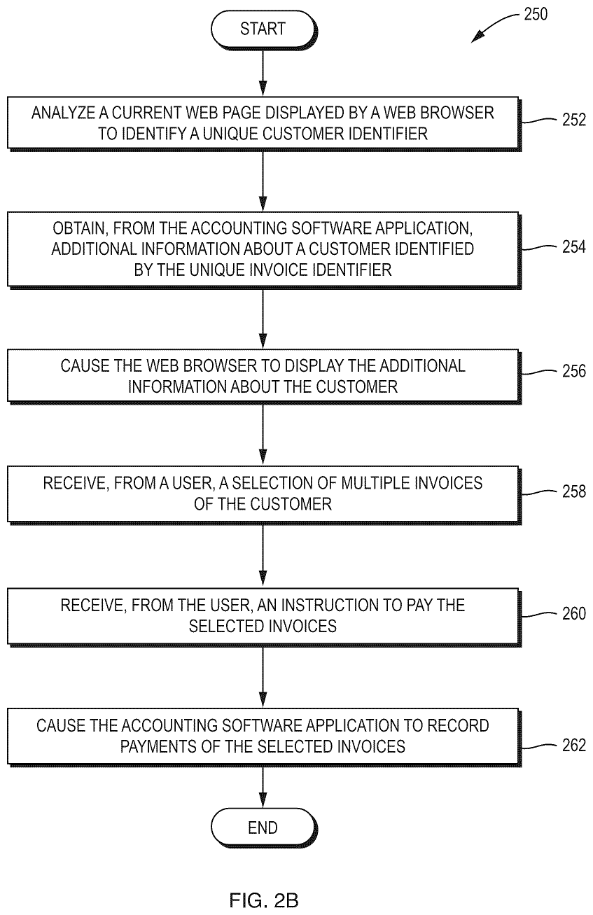

Referring to FIG. 2A, a flowchart is shown of a method 200 performed by the system 100 of FIG. 1 according to one embodiment of the present invention. Assume that, before the method 200 begins, the user 150 has already used the web browser 104 to navigate to the current web page 110. The URL 112 is the URL of the current web page 110. Further assume that the current web page 110 is a web page that has been served by the accounting software application server 120, and which displays an open invoice of a customer within the accounts receivable of the user 150's account with the accounting software application 122.

The method 200 includes analyzing the current web page 110 displayed by the web browser 104 to identify a unique invoice identifier (FIG. 2A, operation 202). Operation 202 may, for example, be performed by the invoice management module 106, which, as described elsewhere herein, may be implemented as a plugin to the web browser 104. As will be described in more detail below, the unique invoice identifier is subsequently used to retrieve additional invoice information and to facilitate payment of the invoice identified by the unique invoice identifier.

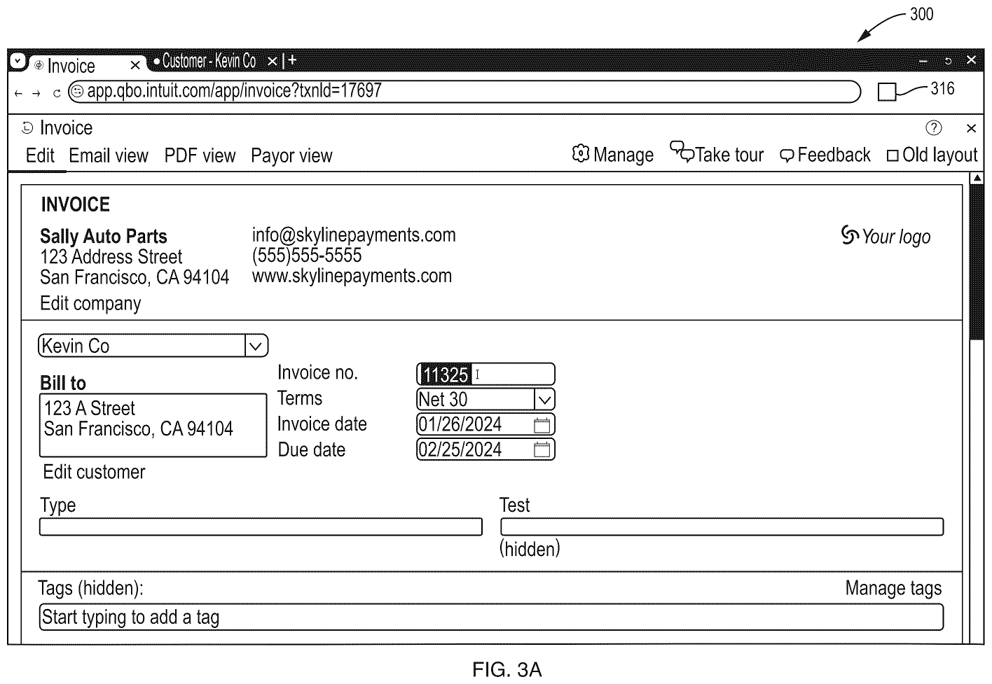

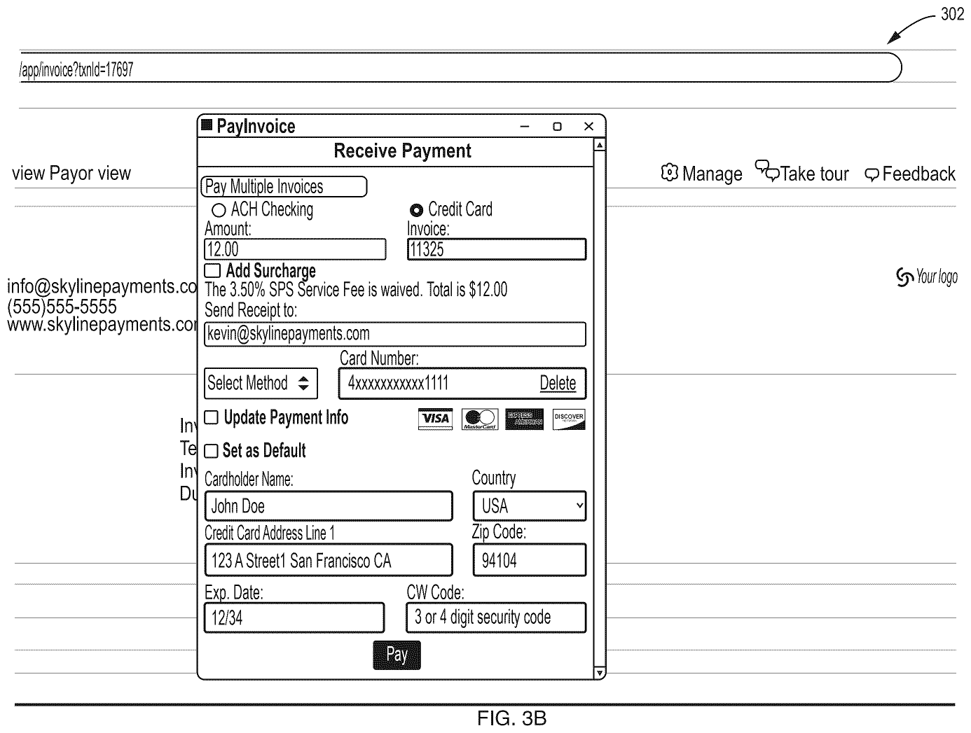

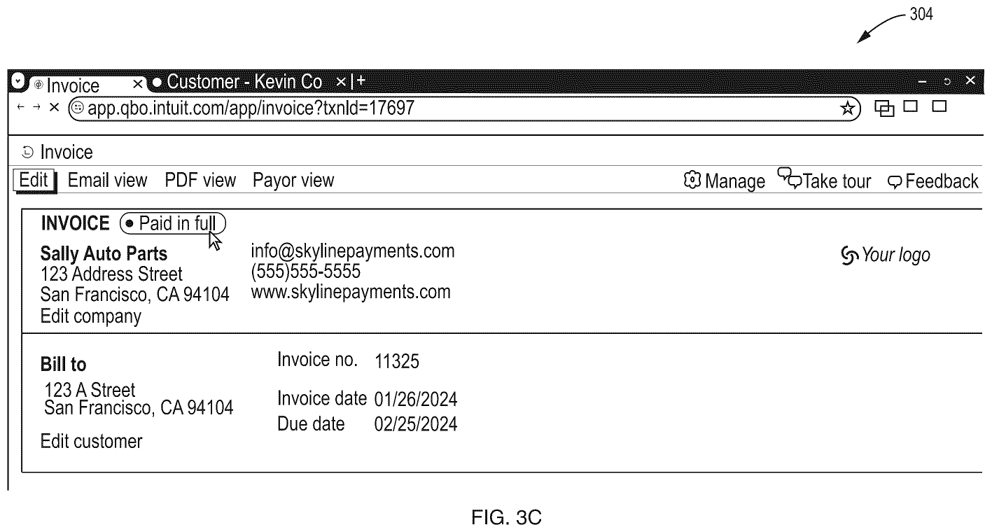

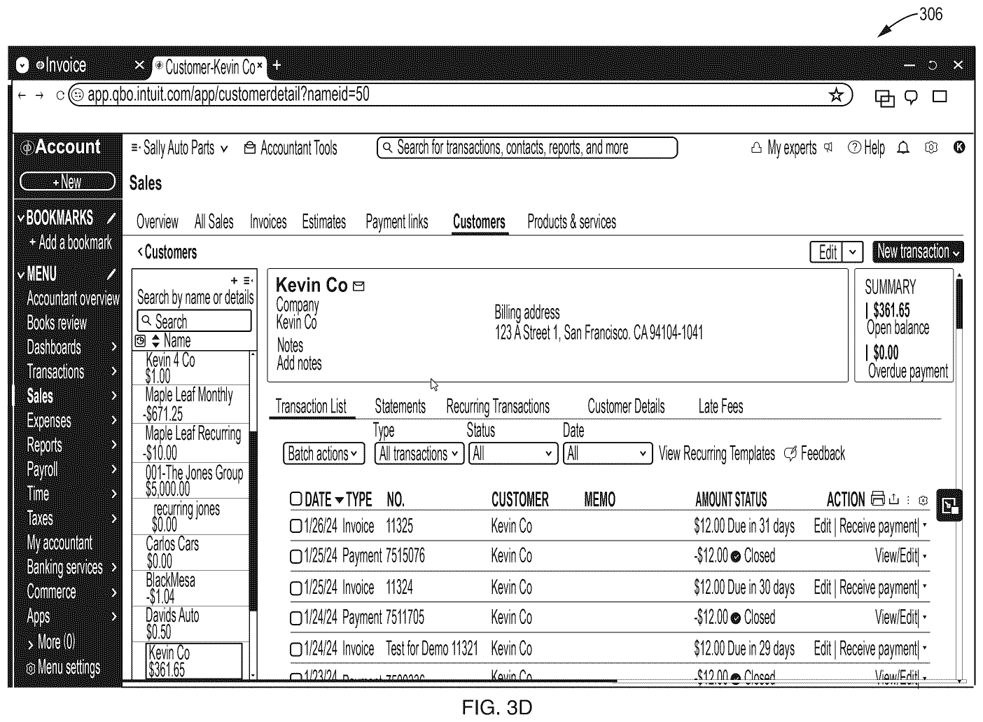

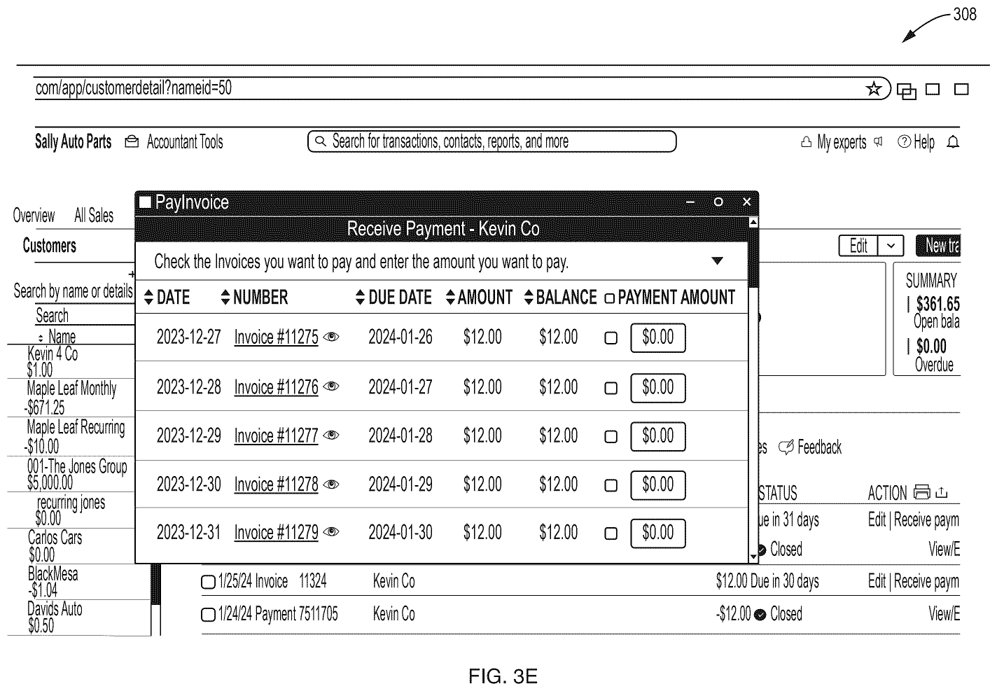

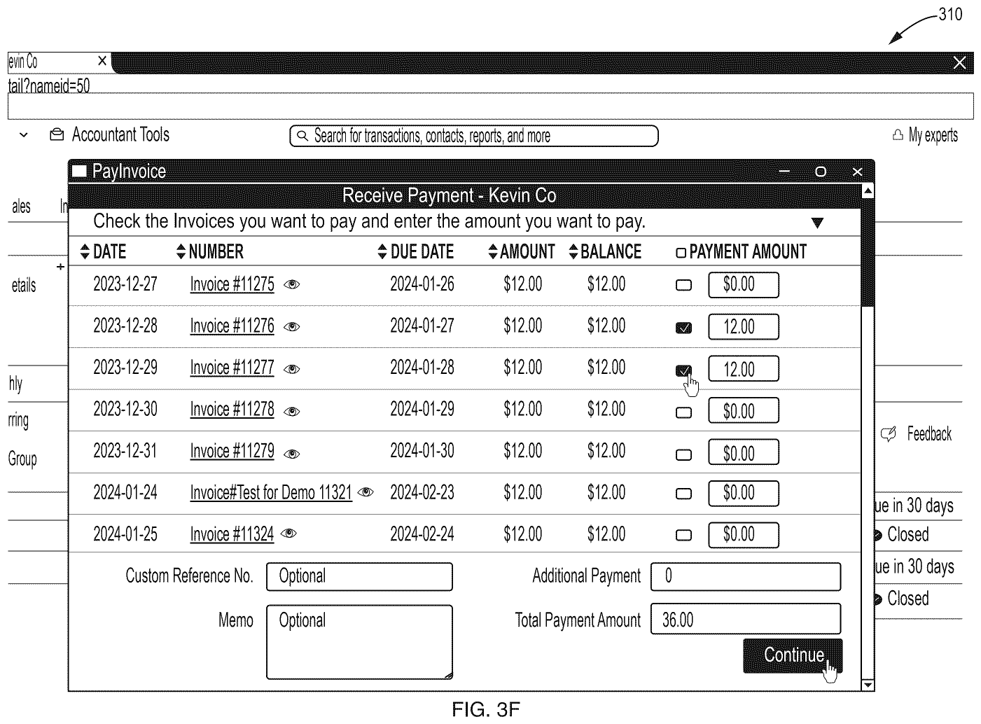

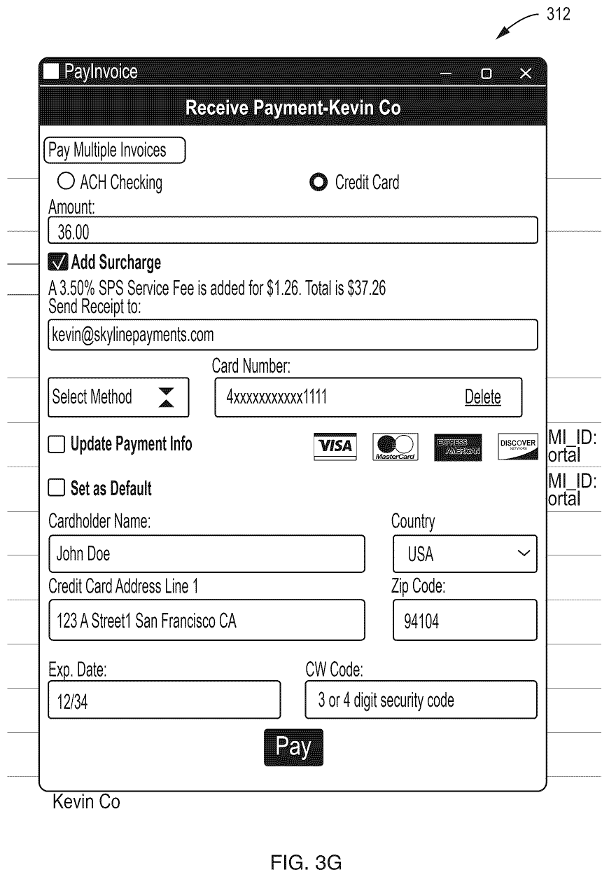

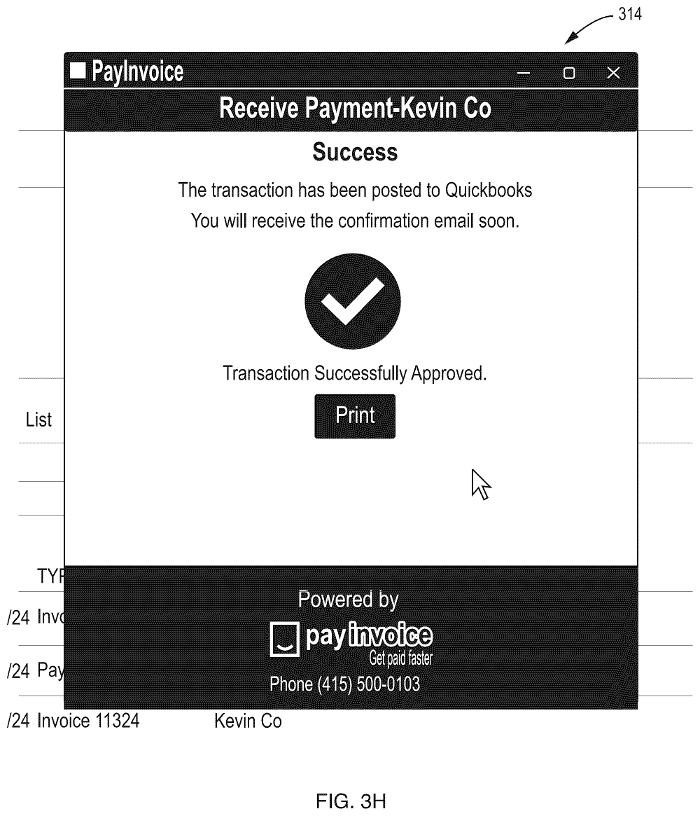

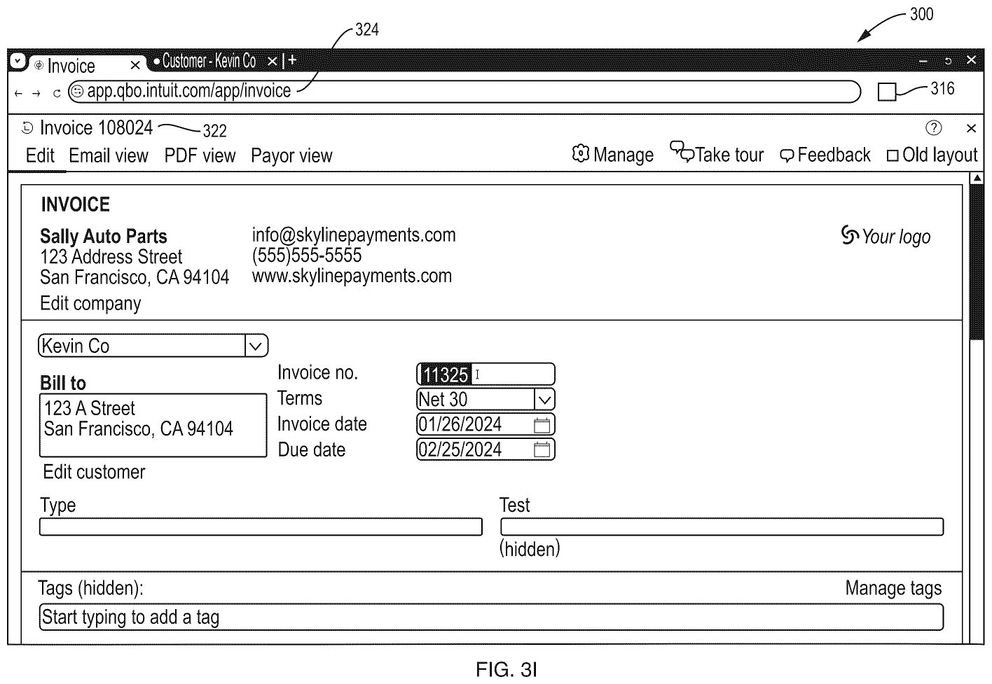

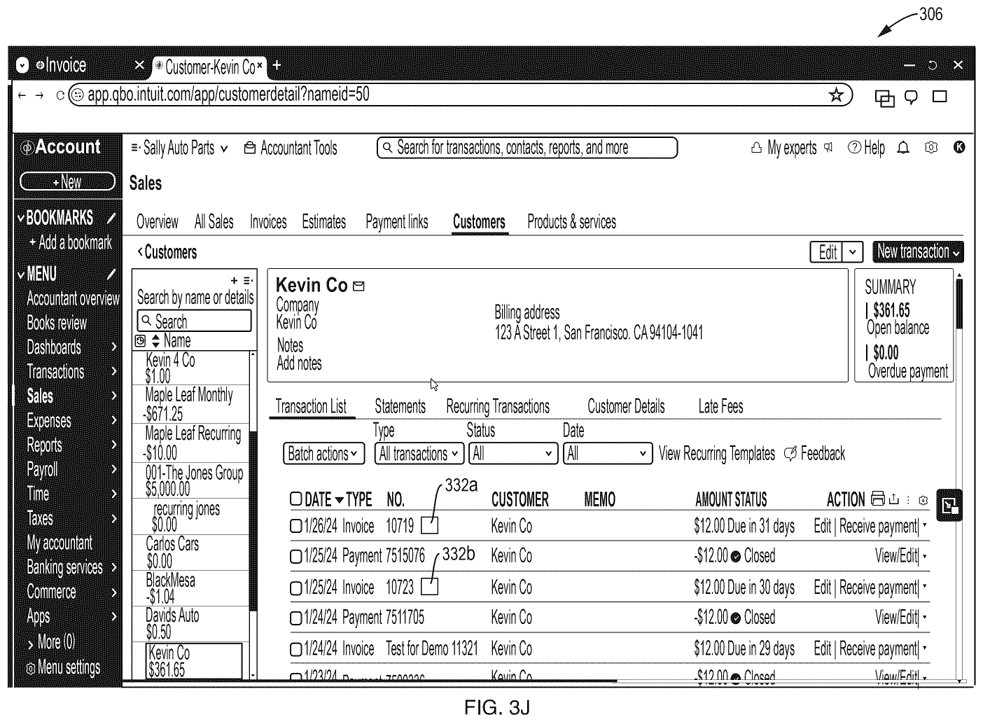

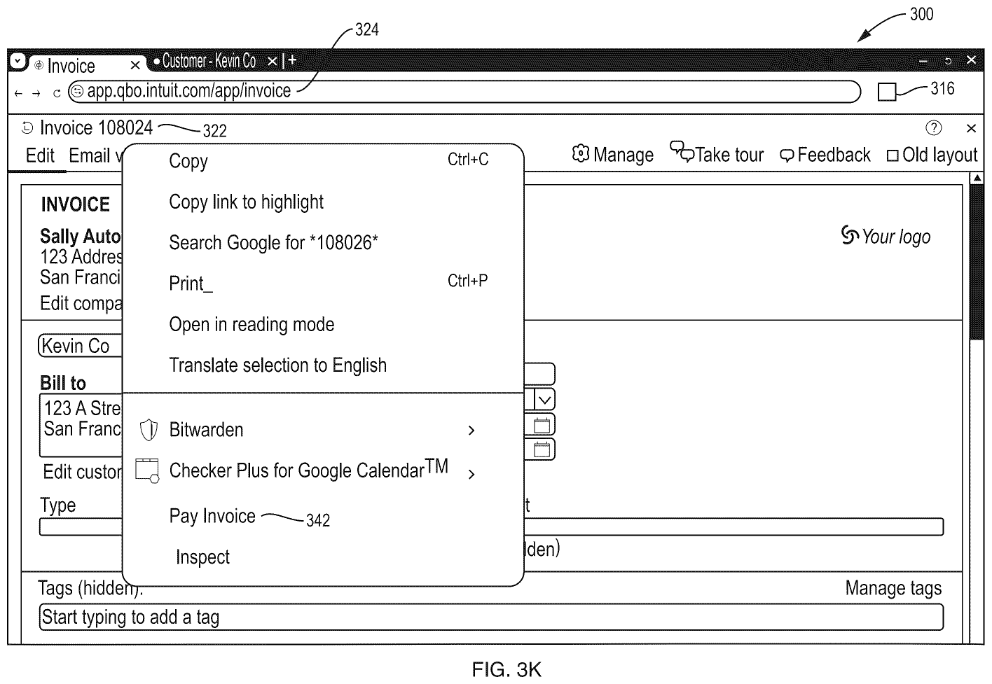

Note that the unique invoice identifier identified by the method 200 in operation 202 may or may not be the invoice identifier that the accounting software application 122 displays to the user 150 to identify the corresponding invoice. For example, in connection with any particular invoice, the accounting software application 122 may create and store a unique invoice identifier for internal purposes. This unique invoice identifier may, for example, be created by the accounting software application 122 at the time of creating the invoice and may not change over time. In addition, the accounting software application 122 may create and store an additional unique invoice identifier, referred to herein as the “user invoice identifier,” which may or may not be the same as the unique invoice identifier. For example, in the example web page 300 of FIG. 3A, the unique invoice identifier can be seen from the URL of the current web page 110 to be 17697, while the user invoice identifier, which is displayed in the text field labeled “Invoice no.”, can be seen to be 11325. As this example illustrates, the unique invoice identifier may not be the same as the user invoice identifier.

If the user 150 changes the user invoice identifier (e.g., to a value other than 11325), the unique invoice identifier may remain the same. The user 150 may store a mapping between the unique invoice identifier and the user invoice identifier in the accounting data 128, which enables the accounting software application 122 to look up the user invoice identifier based on the unique invoice identifier, and to look up the unique invoice identifier based on the user invoice identifier.

Although, as just described, the unique invoice identifier and the user invoice identifier may (and often do) differ from each other, this is not a requirement of the present invention.

Alternatively, for example, the unique invoice identifier and the user invoice identifier may have the same value as each other. As another example, the accounting software application 122 may only maintain the unique invoice identifier, and may use that unique invoice identifier to perform the functions of the user invoice identifier as well, such as by displaying the unique invoice identifier within web pages and other user interfaces (e.g., within the “Invoice no.” field of the web page 300 of FIG. 3A).

Operation 202 may include analyzing any of a variety of aspects of the current web page 110 to identify the unique invoice identifier. For example, the method 200 may analyze the URL 112 of the current web page 110 to identify the unique invoice identifier. As another example, the method 200 may analyze one or more user interface elements of the current web page 110 to identify the unique invoice identifier. As a particular example, the method 200 may analyze a text field on the current web page 110 to identify the unique invoice identifier within that text field. Any reference herein to analyzing the current web page 110 to identify the unique invoice identifier should be understood to include analyzing the URL 112 of the current web page and/or one or more user interface elements of the current web page 110 to identify the unique invoice identifier.

Other examples of information within or related to the current web page 110 that the method 200 may analyze in operation 202 to identify the unique invoice identifier include any one or more of the following, in any combination:
Textual content of the current web page 110, such as visible text that may include invoice numbers, customer names, or other identifying information.
HTML Tags: Specific tags (e.g., <span>, <div>, <p>) that might contain data attributes or text associated with the unique invoice identifier.
Form Fields: Input fields, hidden fields, or other form elements that may contain information that the method 200 may use to identify the unique invoice identifier.
JavaScript Variables: Variables within scripts on the current web page 110 that store the unique invoice identifier and/or information that may be used to identify the unique invoice identifier.
Embedded Objects: Embedded PDFs, images, or other objects that may include the unique invoice identifier and/or information that may be used to identify the unique invoice identifier.
The URL of the current web page 110, which may include query parameters, path segments, and/or URL fragments.
Webpage Metadata, such as meta tags, structured data, Open Graph tags, and/or canonical tags.
HTTP Headers: Response headers from the server that may include custom headers.
Cookies: Cookies set by the website that could store session-specific invoice identifiers.
API Responses: Data returned from API calls made by the current web page 110, which could include JSON or XML structures with invoice identifiers.
Browser History: The browser's history object that could contain URLs of previously visited invoice pages.
Cache Data: Cached data from previous interactions with the invoice page that might store identifiers.

As another example, the method 200 may analyze one or more images of the current web page 110, as rendered by the web browser 104, to identify the unique invoice identifier. Any graphical representation of the current web page 110, as rendered on the user computing device 102 by the web browser 104, is referred to herein as a “rendering” of the current web page 110 or as the “rendered” current web page 110. Any reference herein to an “image” of the current web page 110 includes any such rendering of the current web page 110.

FIG. 3I shows an example of such a rendering 320 of the current web page 110, in which the text “Invoice 108024” 322 represents a unique invoice identifier within the rendering 320 of the current web page 110. Note that, in the example rendering 320 of FIG. 3I, the URL 324 of the current web page 110 does not contain a unique invoice identifier (or any invoice identifier).

Identifying the unique invoice identifier by analyzing a rendering of the current web page 110 can be particularly useful, for example, in scenarios where the unique invoice identifier is embedded within graphical elements or presented in a non-textual format on the rendering of the current web page 110. For example, such techniques may be useful if the rendered current web page 110 includes text representing a unique invoice identifier (e.g., the text “Invoice 108024” 322 in the rendering 320 of FIG. 3I) or an image representing a unique invoice identifier (e.g., an image that may be analyzed to recognize the text “Invoice 108024”).

Identifying the unique invoice identifying by analyzing a rendering of the current web the unique invoice identifier or information that may be analyzed to identify the unique invoice identifier. In such a case, the system 100 may analyze the rendering of the current web page 110 to identify the unique invoice identifier even though the URL 112 of the current web page 110 does not include such a unique invoice identifier.

To facilitate such identification of the unique invoice identifier based on one or more renderings of the current web page 110, the system 100 may, for example, use any of a variety of image analysis techniques, such as Optical Character Recognition (OCR), to identify the unique invoice identifier based on one or more renderings of the current web page 110. The system 100 may, for example, use any of a variety of Al-based techniques (such as those using models that have been trained using machine learning) in the analysis of the current web page 110 that is performed to identify the unique invoice identifier. One such technique involves using one or more Al-based image-to-text models, which are particularly useful for extracting textual data from images embedded in the rendering of the current web page 110. Such models may, for example, utilize convolutional neural networks (CNNs) or similar architectures designed to interpret visual inputs and convert them into machine-readable text. This capability is useful when the invoice identifier is presented in a graphical format, such as within an image or stylized text that standard OCR technology might struggle to interpret accurately.

The system 100 may be equipped with the capability to automatically capture one or more images of the rendered current web page 110, and to use such automatically captured image(s) to identify the unique invoice identifier in any of the ways disclosed herein. This automatic capturing may be executed in any of a variety of ways.

For example, the system 100 may automatically capture one or more images of the rendered current web page, such as by capturing such images at periodic intervals and/or in response to the satisfaction of one or more conditions. Periodic capturing, for example, ensures that the system 100 accommodates any changes or updates that occur on the rendered current web page 110 over time. Any such automatic capturing may, for example, be performed by the system 100 itself, or by another system, such as the operating system of the computing device 102, in which case the system 100 may access any captured image(s) in any of a variety of ways, such as via an API call.

Any captured image of the rendered current web page 110 may, for example, be limited to an image of the rendered current web page 110, or may include only a portion of the rendered current web page 110, or may extend beyond the rendered current web page 110 to include, for example, the entire window containing the rendered current web page 110, or the entire screen on which the rendered current web page 110 is displayed.

The image(s) of the current web page 110 that are analyzed by the system 100 to identify the unique invoice identifier may include, for example, one or more images of the rendered current web page 110 that is currently rendered by the web browser 104, and/or one or more images of renderings of the current web page 110 in one or more previous states. For example, the system 100 may capture or access an image of the web page 110 and analyze that image in any of the ways disclosed herein, even if the web browser 104 is currently rendering a subsequent, changed, version of the current web page 110 that differs from the state of the current web page 110 represented by the analyzed image. The system 100 may even analyze an image of a web page after the web browser 104 has navigated to a different web page, or even after the web browser 104 is no longer executing. This allows the system 100 to perform the functions disclosed herein asynchronously with the operation of the web browser 104.

The method 200 may use any of a variety of user interface elements to interact with the user 150 as part of analyzing the current web page 110 in operation 202 to identify the unique invoice identifier, such as any one or more of the following, in any combination:
Text Selection: The user 150 may select text on the current web page 110, and the invoice management module 106 may analyze that text to identify the unique invoice identifier. The selected text may, for example, include or consist of the unique invoice identifier, or the invoice management module 106 may identify the unique invoice identifier based on the selected text.
Context Menu Option: When the user 150 right-clicks on the current web page 110, the invoice management module 106 may analyze the text at the current cursor position or the text currently selected by the user to identify the unique invoice identifier in any of the ways disclosed herein.
Interactive Highlighting: The invoice management module 106 may automatically identify and highlight potential identifiers on the current web page 110, and the user 150 may provide input (e.g., click on) any such highlighted text to select text that represents the unique invoice identifier.
Drag-and-Drop Functionality: The user 150 may drag a piece of text or an element from the current web page 110 and drop it into a designated area of the invoice management module 106's interface to identify the unique invoice identifier.
Button or Link Overlays: The invoice management module 106 may overlay buttons or links next to potential unique invoice identifiers on the current web page 110. The user 150 may click one of these to provide the selected unique invoice identifier to the invoice management module 106 for processing.
Keyboard Shortcuts: The invoice management module 106 may predefine keyboard shortcuts, and the user 150 may provide input using one of those predefined keyboard shortcuts to capture the unique invoice identifier when it is selected or when the cursor is positioned near it on the current web page 110.
Tooltip Suggestions: When the user 150 hovers over a potential unique invoice identifier, the invoice management module 106 may display a tooltip to suggest that the user 150 can click to select the hovered-over unique invoice identifier for the invoice management module 106 to process.

Referring to FIG. 3A, a diagram is shown of an example web page 300 displayed by the web browser 104 at the time of operation 202 according to one embodiment of the present invention. In the example of FIG. 3A, the web page 300 displays information about an invoice that is open in the user 150's accounting data 128 in the accounting software application 122. The web page 300 may, for example, be a conventional web page that is displayed by the accounting software application 122 via the web browser 104 to display information about an open invoice in the user 150's accounting data 128. As can be seen in FIG. 3A, the web page 300 includes a variety of information about the open invoice, such as the user invoice number, terms, invoice date, due date, and customer details. The particular structure, content, and layout of the web page 300 shown in FIG. 3A are merely examples and do not constitute limitations of the present invention.

The invoice management module 106 may initiate the analysis of the current web page 110 (e.g., the URL 112 of the current web page 110 and/or one or more user interface elements of the current web page 110) in operation 202 in response to any of a variety of triggers. For example, the user 150 may provide input 154 to the invoice management module 106, in response to which the invoice management module 106 may perform operation 202. As a particular example, the user 150 may select a user interface element displayed by the web browser 104. An example of such a user interface element is a button associated with a web browser plugin that implements the invoice management module 106. An example of such a button 316 is shown in the upper right corner of the web page 300 of FIG. 3A. The user 150 may press that button 316, in response to which the invoice management module 106 may perform operation 202. As this example illustrates, the invoice management module 106 may perform operation 202 in response to as little as a single input (e.g., a selection of or other interaction with a single user interface element) by the user 150.

The invoice management module 106 may analyze the current web page 110 in any of a variety of ways to identify the unique invoice identifier. For example, the invoice management module 106 may analyze the current web page 110 to locate a specific pattern or sequence of characters that is known to precede, follow, or encapsulate the unique invoice identifier within one or more features of the current web page 110 (e.g., within the URL 112, within any image of the current web page 110, and/or within one or more user interface elements of the current web page 110). The invoice management module 106 may use any of a variety of pattern matching algorithms to identify the unique invoice identifier within the current web page 110 (e.g., within the URL 112, within any image of the current web page 110, and/or within one or more user interface elements of the current web page 110).

The invoice management module 106 may, for example, employ a pattern matching algorithm that has been preconfigured with knowledge of the structure and syntax used by the accounting software application 122 to embed invoice identifiers within the current web page 110 (e.g., within the URL 112, within any image of the current web page 110, and/or within one or more user interface elements of the current web page 110). This algorithm may parse the current web page 110 to detect the presence of predetermined strings (e.g., delimiters) that signal the start and end points of the unique invoice identifier.

Once the relevant pattern is identified within the current web page 110, the invoice management module 106 isolates the unique invoice identifier from the surrounding characters. This identifier is a distinctive sequence of numbers, letters, or a combination thereof, which the accounting software application 122 assigns to each invoice as a means of unambiguous identification.

As noted elsewhere, embodiments of the present invention may be used with a variety of different software accounting applications. As this implies, the accounting software application 122 may merely be one instance of an accounting software application (e.g., QuickBooks Online) that is suitable for use with embodiments of the present invention. Although not shown in FIG. 1, an instance of a different accounting software application (e.g., Freshbooks) may also be suitable for use with embodiments of the present invention. Each such accounting software application may employ a different format for encoding unique invoice identifiers (e.g., within the URL 112 and/or within one or more user interface elements of the current web page 110), each having its own distinct way of embedding or otherwise encoding unique invoice identifiers. For example, two different accounting software applications may use different text string patterns to delimit or otherwise encode unique invoice identifiers. The invoice management module 106 may be configured with distinct pattern matching algorithms for such distinct text string patterns. When the invoice management module 106 analyzes the current web page 110 in operation 202, the invoice management module 106 may, for example, identify the accounting software application 122 and select the appropriate pattern matching algorithm for use in connection with that accounting software application 122. As this implies, the invoice management module 106 may use different pattern matching algorithms (or patterns) to identify unique invoices identifiers within the current web page 110 (e.g., within the URL 112 and/or within one or more user interface elements of the current web page 110), depending on the identity of the accounting software application 122. For example, the invoice management module 106 may use a first pattern matching algorithm (or pattern) to identify unique invoice identifiers within web pages of a first accounting software application, and may use a second, different, pattern matching algorithm (or pattern) to identify unique invoices identifiers within web pages of a second accounting software application.

Although the unique invoice identifier that is identified by the invoice management module 106 in operation 202 may be contained within the current web page 110 (e.g., within the URL 112 and/or within one or more user interface elements of the current web page 110), and the invoice management module 106 may identify the unique invoice identifier within the current web page 110, this is merely an example and does not constitute a limitation of the present invention. More generally, the invoice management module 106 may identify the unique invoice identifier based on the current web page 110 in any of a variety of ways, whether or not the unique invoice identifier is contained within the current web page 110. For example, the invoice management module 106 may perform any of a variety of processing on the current web page 110 to generate, derive, or otherwise identify the unique invoice identifier based on the current web page 110, even if the unique invoice identifier is not contained within the current web page 110. In particular, the invoice management module 106 may perform any of a variety of processing on the URL 112 to generate, derive, or otherwise identify the unique invoice identifier based on the URL 112, even if the unique invoice identifier is not contained within the URL 112.

The method 200 also includes obtaining, from the accounting software application 122, additional information about an invoice identified by the unique invoice identifier (FIG. 2A, operation 204). Operation 204 may, for example, be performed by the invoice management module 106. The invoice management module 106 may obtain the additional information about the invoice from the accounting software application 122 using any suitable communications 116 and 126 between the invoice management module 106 and the accounting software application 122, via the accounting software application API 124.

More specifically, for example, the invoice management module 106 may initiate a request to the accounting software application 122 via the accounting software application API 124. This request may be structured to include the unique invoice identifier as a parameter, thereby instructing the accounting software application 122 to return data associated with that specific invoice. The API 124 serves as a conduit for communication between the invoice management module 106 and the accounting software application, allowing for the exchange of information in a structured and standardized format.

Upon receiving the request, the accounting software application 122 may query the accounting data 128 (e.g., the accounts receivable portion of the user 150's account with the accounting software application 122) to locate the invoice corresponding to the provided unique invoice identifier. The accounting data 128, which stores comprehensive records of all transactions, including customer details, invoice amounts, due dates, payment statuses, and associated payment methods, may be searched by the accounting software application 122 to compile all relevant information pertaining to the identified invoice.

The accounting software application accounting software application 122 extracts the requested invoice information from the accounting data 128. This information may include, but is not limited to, customer information (e.g., any one or more of the customer name, company name, customer contact information, customer account number or identifier, customer purchase order number, customer's preferred payment method(s)), invoice details (e.g., any one or more of customer invoice identifier, unique invoice identifier, date of issue, due date, description of goods or services provided, quantity of goods or services, unit price and line item totals, subtotal, taxes, discounts, total amount due, currency type), and payment information (e.g., payment status, payment terms, payment history, remaining balance, late fees, interest accrued).

Recall that the unique invoice identifier that the invoice management module 106 identifies in operation 202 may or may not be the same as the customer invoice number that the accounting software application 122 provides to the user 150. Therefore, when the accounting software application 122 extracts the requested invoice information from the accounting data 128, that extraction may include using the previously-described mapping between the unique invoice identifier and the corresponding user invoice identifier to lookup the corresponding user invoice identifier based on the unique invoice identifier. The resulting user invoice identifier may be among the additional invoice information that the accounting software application 122 extracts from the accounting data 128 based on the unique invoice identifier.

The accounting software application 122 transmits the extracted information back to the invoice management module 106 over the network 118 via the accounting software application API 124. The data may be sent in various formats, such as JSON or XML, which are easily parsed by the invoice management module 106 to facilitate the display of information to the user 150 via the user interface 152.

As previously described, in some embodiments, the invoice management module 106 may cache the obtained information locally on the computing device 102, either after receiving such data in response to a request as described, or in advance, thereby eliminating the need for such a request to be made to the accounting software application 122 at the time when the current web page 110 is displayed by the web browser 104. Such caching allows for quicker access to invoice details in subsequent interactions and reduces the need for repeated data retrieval from the accounting software application accounting software application 122, thereby enhancing performance of the system 100 and the user 150's experience.

The method 200 may further include causing the web browser 104 to display the additional information about the invoice (FIG. 2A, operation 206). Operation 206 may be performed by the invoice management module 106 and/or the invoice management server 160. Displaying the additional information about the invoice enhances the user experience by providing immediate access to comprehensive invoice details directly within the web browsing environment. The invoice management module 106 may cause the web browser 104 to display the additional information about the invoice in any of a variety of ways, such as any one or more of the following:
Pop-Up Window: A pop-up window or modal dialog box can be generated by the invoice management module 106, overlaying the display of the current web page 110 in the output 156 of the user interface 152. This window may be designed to present the additional invoice information in an organized and easily readable format, allowing the user 150 to review details without navigating away from the current page. An example of such a pop-up window 302 is shown in FIG. 3B.
Sidebar or Panel: An alternative to a pop-up window is a sidebar or panel that slides out from the edge of the display of the current web page 110. This panel may contain the additional invoice information and may be expanded or collapsed by the user 150 as needed, providing a non-intrusive yet accessible means of reviewing invoice details.
Dedicated Tab or Window: The invoice management module 106 may open a new browser tab or window dedicated to displaying the additional invoice information. This approach allows the user 150 to view the additional invoice information while simultaneously viewing the current web page 110, or to alternative between the additional invoice information and the current web page 110.
In-Page Overlay: The additional invoice information may be displayed via an in-page overlay, which inserts the additional invoice information directly into the current web page 110's content. This method may be designed, for example, to dim the background content, focusing the user 150's attention on the invoice details.
Interactive Notifications: For brief highlights or critical information, the invoice management module 106 may use interactive browser notifications. These notifications may provide a summary of the invoice details and offer the user 150 the option to click through to view more comprehensive information.
Dynamic Content Injection: The invoice management module 106 may dynamically inject content into the current web page 110, creating sections or widgets that display the additional invoice information. This method allows for a seamless integration of data within the existing web page layout.
Responsive Design: Regardless of the chosen display method, the invoice management module 106 may ensure that the presentation of the additional invoice information is responsive and adapts to different screen sizes and resolutions, catering to a variety of devices such as desktops, laptops, tablets, and smartphones.

As mentioned above, FIG. 3B shows an example of an embodiment in which the invoice management module 106 displays the additional information about the invoice in the form of a pop-up window 302. In the example of FIG. 3B, the pop-up window 302 is shown as overlaying the web page 302 that displays the invoice details. The pop-up window 302 includes a variety of information, such as the invoice number, amount due, customer email address, user interface elements for displaying and/or editing the customer's payment method, and a “Pay” button. The particular structure, content, and layout of the pop-up window 302 shown in FIG. 3B are merely examples and do not constitute limitations of the present invention.

Recall that the system 100 may analyze the current web page 110 and/or a rendering of the current web page 110 to identify one or more unique invoice identifiers within the current web page 110 and/or the rendering of the current web page 110. Once the system 100 has analyzed the current web page 110 and/or a rendering of the current web page 110 to identify one or more unique invoice identifiers within the current web page 110 and/or the rendering of the current web page 110, the system 100 may modify the current web page 110 and/or the rendering of the current web page 110 to provide, for each identified unique invoice identifier, a corresponding user interface element that may be selected by the user 150 to trigger operations 204 and/or 206.

For example, the example web page 330 of FIG. 3J displays information about a plurality of invoices, having unique invoice identifiers 10719 and 10723. In the web page 330 of FIG. 3J, the system 100 has modified the web page 330 to include: (1) a first user interface element 332a (e.g., a button) that is associated with (e.g., adjacent to) the first unique invoice identifier (“10719”); and (2) a second user interface element 332b that is associated with (e.g., adjacent to) the second unique invoice identifier (“10723”).

The user 150 may provide input selecting the first user interface element 332a, in response to which the 100 may identify, in the web page 330, the unique invoice identifier (“10719”) that is associated with the first user interface element 332a, and perform operations 204 and/or 206 in connection with the first unique invoice identifier. Similarly, the user 150 may provide input selecting the second user interface element 332b, in response to which the 100 may identify, in the web page 330, the unique invoice identifier (“10723”) that is associated with the second user interface element 332b, and perform operations 204 and/or 206 in connection with the first unique invoice identifier. Note that the web page 330 may include the first user interface element 332a and the second user interface element 332b instead of, or in addition to, the page-wide button 316 shown in FIG. 3A.

Such user-specific user interface elements (e.g., the buttons 332a and 332b) may be inserted dynamically into the current web page 110, and/or into a rendering of the current web page 110, by the system 100. For example, the original version of the current web page 110 may lack such user interface elements, and the system 100 may insert into the current web page 110, for each unique invoice identifier that the system 100 identifies in the current web page 110 using any of the techniques disclosed herein (such as by analyzing a rendering of the current web page 110), a corresponding user interface element.

Although buttons 332a-b are shown in FIG. 3J as examples of such user interface elements, these are merely examples and do not constitute limitations of the present invention. As another example, the system 100 may associate a hyperlink within a unique invoice identifier in the current web page 110 (e.g., the text “10719” in the web page 330 of FIG. 3J). As yet another example, the system 100 may modify the appearance (e.g., highlight, bold, underline, change the font, or change the color) of the unique invoice identifier in the current web page 110. The user 150 may select or otherwise interact with any such user interface element in the current web page 110, in response to which the system 100 may perform any of the actions disclosed herein, such as performing operations 204 and/or 206 in the method 200.

Although adding or modifying a user interface element in association with one or more unique invoice identifiers in the current web page 110 and/or a rendering of the current web page 110 is particularly useful when the current web page 110 contains multiple unique invoice identifiers (as in the example web page 330 of FIG. 3J), the system 100 may perform such modification even if the current web page 110 contains only a single unique invoice identifier, or even if the system 100 identifies only a single unique invoice identifier within the current web page 110.

The descriptions above are merely examples of actions that may trigger the system 100 to perform operations 204 and/or 206. The web page 340 of FIG. 3K illustrates another example. The web page 340 of FIG. 3K may, for example, be the same as or similar to the web page 320 of FIG. 3I, in that the web page 340 of FIG. 3K may contain text including a unique invoice identifier, e.g., “Invoice 108024.” The user 150 may provide input, referred to herein as “menu triggering input,” in connection with the displayed unique invoice identifier, such as by right-clicking or Control-clicking on the rendering of the unique invoice identifier (e.g., the text “Invoice 108024”). In response to receiving the menu triggering input, the system 100 may display a menu, such as the contextual menu 342 shown in FIG. 3K. The menu may include a payment triggering menu item, such as the “Pay Invoice” menu item 342 shown in FIG. 3K. The payment triggering menu item may be associated with the unique invoice identifier whose selection cause the menu to be displayed (e.g., the unique invoice identifier 108026 in FIG. 3K).

The user 150 may select the payment triggering menu item, such as by clicking or tapping on the payment triggering menu item (e.g., the menu item 342 in FIG. 3K), in response to which the system 100 may perform operations 204 and/or 206 in connection with the unique invoice identifier that is associated with the payment triggering menu item, namely the unique invoice identifier that the user 150 selected to cause the menu to be displayed (e.g., the unique invoice identifier 108026 in FIG. 3K).

The process described above in connection with FIG. 3K is merely another example of a variety of processes that the system 100 may perform to identify a unique invoice identifier to use within the method 200. In particular, the process described above in connection with FIG. 3K is merely another example of a way that system 100 may identify a unique invoice identifier to use in operations 204-210 of the method 200, which may be performed in any of the ways disclosed herein, regardless of how the system 100 identified the unique invoice identifier.

Furthermore, it should be understood that the process described above in connection with FIG. 3K (e.g., displaying a menu and enabling the user 150 to select a payment triggering menu item within that menu) may be performed by the 100 in connection with any user interface, not merely the user interface shown in FIG. 3K. For example, the system 100 may perform the same or similar process in connection with the user interface shown in FIG. 3J, in which multiple unique invoice identifiers are displayed, in which case the system 100 may perform the menu display and selection process in connection with any one or more of the displayed unique invoice identifiers.

The method 200 may also include receiving, from the user 150, an instruction to pay the invoice identified by the unique invoice identifier (FIG. 2A, operation 208). Operation 208 may be performed by the invoice management module 106 and/or the invoice management server 160.

The invoice management module 106 may receive the user 150's instruction to pay via any of a variety of user interface mechanisms, such as any one or more of the following:
Payment Button: The most straightforward implementation is a “Pay” button displayed within the pop-up window, sidebar, or other dedicated user interface element in which the additional invoice information is presented. The user 150 may initiate payment by clicking, tapping, or otherwise selecting this button. An example of such a “Pay” button is shown in the pop-up window 302 of FIG. 3B.
Interactive Form: The user 150 may be presented with an interactive form that includes a payment button along with options to select a payment method, enter payment details, or confirm the amount to be paid. Submission of this form serves as an instruction to pay the invoice.
Voice Command: In systems equipped with voice recognition capabilities, the user 150 may provide a verbal instruction to pay the invoice. The invoice management module 106 may interpret this voice command as the user 150's intent to initiate payment.
Gesture Control: For touch-enabled devices, the user 150 may use a specific gesture, such as a swipe or tap-and-hold, on the displayed invoice information to indicate their desire to pay the invoice.
Keyboard Shortcut: Power users may prefer using keyboard shortcuts to expedite their workflow. The invoice management module 106 may be configured to recognize a predefined key combination as an instruction to pay the invoice.
Confirmation Dialog: To prevent accidental payments, the invoice management module 106 may implement a confirmation dialog that appears after the initial instruction is received. The user 150 must then confirm their intent to pay the invoice, thereby providing a two-step verification process.
Payment Links: The displayed invoice information may include a hyperlink or QR code that, when clicked or scanned, signifies the user 150's instruction to pay the invoice. This method can be particularly useful for mobile devices.
API-Driven Payment: For users who prefer automated or programmatic interactions, the invoice management module 106 may offer an API endpoint that accepts payment instructions from external scripts or systems managed by the user 150.
Biometric Authentication: In systems with biometric capabilities, such as fingerprint or facial recognition, the user 150's instruction to pay may be confirmed through a biometric prompt, adding a layer of security to the payment authorization process.

Each of these implementations provides a different method for the user 150 to convey their payment instruction, catering to diverse user 150 preferences and ensuring that the payment process is both user 150-friendly and secure. The invoice management module 106 may be designed to accommodate various user 150 interactions, making the payment process as intuitive and efficient as possible.

Before the user 150 provides the instruction to pay the invoice, the 150 may provide input containing information about a payment method to be used to pay the invoice. For example, the additional invoice information displayed in operation 206 may include information about a payment method associated with the customer who is associated with the invoice, such as that customer's preferred payment method. Such payment method information may, for example, be displayed within the same user interface element (e.g., window) as the additional invoice information.

The invoice management module 106 may provide the user 150 with the opportunity to review, approve, and/or edit the payment information before proceeding with the payment instruction. For example, upon displaying the invoice details within the web browser 104 in operation 206, the invoice management module 106 may also display the payment method preferred by the customer for settling the invoice. This payment method may for example, be a credit card, bank account, or any other payment option that the customer has previously selected or that is associated with the customer's account within the accounting software application 122.

The invoice management module 106 may control the user interface 152 to allow the user 150 to interact with the displayed payment information to review the customer's preferred payment method to ensure that it is the correct and intended source of payment for the invoice. If the payment method is correct, the user 150 may approve the use of this method with a simple confirmation action, such as clicking an “Approve” button, or merely by taking no action in connection with the payment information, in which case the user 150's issuance of the payment instruction constitutes the user 150's implicit approval of the payment information.

If the user 150 needs to change the payment method—for example, if the customer has updated their preferred payment method or if a different payment source is to be used—the user 150 may select an “Edit” option which allows the user 150 to modify the payment details, such as changing the credit card number, updating the expiration date, or selecting a different bank account. An example of such an “Edit” option is shown in the pop-up window 302 of FIG. 3B, in which the user 150 may select the “Update Payment Info” checkbox, in response to which the invoice management module 106 may enable the user 150 to edit the payment method information (e.g., card number, cardholder name, credit card address, zip code, country, expiration date, and/or CVV code) via the pop-up window 302.

After any necessary edits are made, the user 150 may, via the user interface 152, issue an instruction to save the updated payment information, in response to which the invoice management module 106 may interact with the accounting software application 122 to save the updated payment method information into the user 150's account in the accounting data 128. Issuing an instruction to pay the invoice may be interpreted by the invoice management module 106 as a combined instruction to both save any updates to the payment method information and to pay the invoice using the updated payment method information. The resulting updated payment method information is then subsequently used by the accounting software application 122 to process payment of the invoice in any of the ways disclosed below.

This feature enhances the payment process by offering the user 150 the convenience of managing payment methods directly, the flexibility to select the most suitable payment source, the accuracy to reduce errors, the control to ensure appropriate use of the customer's preferred method, the ability to improve customer satisfaction, and the security of using up-to-date and secure payment information.

The method 200 may also include, in response to receiving the instruction to pay the invoice identified by the unique invoice identifier, causing the accounting software application 122 to record a payment of the invoice identified by the unique invoice identifier (FIG. 2A, operation 210). Operation 210 may be performed by the invoice management module 106 and/or the invoice management server 160.

In response to receipt of the user 150's instruction to pay the invoice, the invoice management module 106 may communicate with the accounting software application 122 to trigger the recording of a payment against the invoice associated with the unique invoice identifier. This process can be implemented through any of a variety of methods. For example, the invoice management module 106 may make an API call to the accounting software application 122 via the accounting software application API 124, sending a request that includes the unique invoice identifier and payment details such as the amount, payment method, and date. The accounting software application 122 then processes the request and records the payment, including updating the accounting data 128 accordingly.

As another example, the 106 may simulate the submission of a payment form within the accounting software application 122's user interface, auto-filling the necessary fields with the invoice identifier and payment information before programmatically submitting the form. As yet another example, if the invoice management module 106 has direct access to the accounting data 128, it can execute a database command to update the invoice record with the payment details, marking the invoice as paid or partially paid as appropriate. As yet another example, the invoice management module 106 may integrate with a payment processor that, once the payment is confirmed, communicates with the accounting software application 122 to update the invoice status accordingly in the accounting data 128. Regardless of the mechanism that is employed to cause the accounting software application 122 to process the invoice payment, the benefits of this feature include streamlined payment processing, reduced manual data entry, minimized errors, and real-time updating of the account data 128. By automating the payment recording process, the system 100 ensures that the accounting software application 122 reflects the most current payment status, thereby maintaining accurate and up-to-date financial information.

The invoice management module 106 may optionally provide output 156 to the user 150 to indicate a confirmation that the invoice has been paid. An example of such output 156 is shown in FIG. 3C in the form of a web page 304 in which the invoice is shown as having been paid in full. Although not shown in FIG. 3C, such output 156 may also show that the balance of the paid invoice is now zero.

A second embodiment of the present invention provides a method for managing and processing one or more open invoices for a customer within the user 150's accounting data 128 in the accounting software application 122. This second embodiment will now be described. Various aspects of this second embodiment operate in the same or similar manner to the first embodiment, in which a single displayed invoice is processed for payment. As a result, the following description will focus on aspects of the second (customer-based) embodiment, and it should be assumed that any aspects of the second embodiment that are not described below may be implemented in any of the ways disclosed herein in connection with the first (invoice-based) embodiment.

Referring to FIG. 2B, a flowchart is shown of a method 250 performed by the system 100 of FIG. 1 according to the second embodiment of the present invention. Assume that, before the method 250 begins, the user 150 has already used the web browser 104 to navigate to the current web page 110. Further assume that the current web page 110 is a web page that has been served by the accounting software application server 120, and which displays information about a particular customer within the accounts receivable of the user 150's account with the accounting software application 122. Such information may include, for example, information about a plurality of open invoices of the customer within the accounts receivable section of the user 150's accounting data 128 in the accounting software application 122.

The method 250 includes analyzing the current web page 110 displayed by the web browser 104 (e.g., the URL 112 and/or within one or more user interface elements of the current web page 110) to identify a unique customer identifier (FIG. 2B, operation 252). Operation 252 may, for example, be performed by the invoice management module 106, which, as described elsewhere herein, may be implemented as a plugin to the web browser 104. As will be described in more detail below, the unique customer identifier is subsequently used to retrieve additional customer information and to facilitate payment of one or more of the customer's open invoices.

Referring to FIG. 3B, a diagram is shown of an example web page 306 displayed by the web browser 104 at the time of operation 252 according to one embodiment of the present invention. In the example of FIG. 3B, the web page 306 displays information about a customer of the user 150 in the user 150's accounting data 128 in the accounting software application 122. As can be seen in FIG. 3B, the web page 306 includes a variety of information about the customer, such as the customer's name and address, and information about a plurality of the customer's invoices (including both open and closed invoices). The particular structure, content, and layout of the web page 306 shown in FIG. 3B are merely examples and do not constitute limitations of the present invention.

The invoice management module 106 may initiate the analysis of the current web page 110 in operation 252 in response to any of a variety of triggers. For example, the user 150 may provide input 154 to the invoice management module 106, such as by pressing the web browser plug-in button previously described, in response to which the invoice management module 106 may perform operation 252.

The invoice management module 106 may analyze the current web page 110 in any of the ways disclosed above in connection with analyzing the current web page 110 to identify the unique invoice identifier, but instead to identify the unique customer identifier. The invoice management module 106 may, for example, employ a pattern matching algorithm that has been preconfigured with knowledge of the structure and syntax used by the accounting software application 122 to embed customer identifiers within web pages (e.g., URLs and/or user interface elements, such as text fields). This algorithm may parse the current web page 110 (e.g., the URL 112 and/or one or more user interface elements of the current web page 110) to detect the presence of predetermined strings (e.g., delimiters) that signal the start and end points of the unique customer identifier.

The method 250 also includes obtaining, from the accounting software application 122, additional information about the customer identified by the unique customer identifier (FIG. 2B, operation 254). Such additional information about the customer may include, for example, non-invoice information about the customer (such as the customer's name and address) and/or invoice-specific information about the customer (such as information about a plurality of open invoices of the customer within the accounts receivable section of the user 150's accounting data 128 within the accounting software application 122).

Operation 254 may, for example, be performed by the invoice management module 106. The invoice management module 106 may obtain the additional information about the customer from the accounting software application 122 using any suitable communications 116 and 126 between the invoice management module 106 and the accounting software application 122, via the accounting software application API 124.

The method 250 may further include causing the web browser 104 to display the additional information about the customer (FIG. 2B, operation 256). Operation 256 may be performed by the invoice management module 106 and/or the invoice management server 160. Displaying the additional information about the customer may include, for example, displaying non-invoice information about the customer (such as the customer's name and address) and/or invoice-specific information about the customer (such as information about a plurality of open invoices of the customer within the accounts receivable section of the user 150's accounting data 128 within the accounting software application 122).

The display of the additional information about the customer may, for example, take any of the forms disclosed herein in connection with the display of the additional invoice information (e.g., as shown in FIG. 3B). As a particular example, a pop-up window or modal dialog box can be generated by the invoice management module 106, overlaying the display of the current web page 110 in the output 156 of the user interface 152. This window may be designed to present the additional customer information in an organized and easily readable format, allowing the user 150 to review details without navigating away from the current page.

An example of such a pop-up window 308 containing customer information, including a plurality of open invoices of the customer, is shown in FIG. 3E.

The method 250 may also include receiving, from the user 150, a selection of one or multiple invoices within the plurality of open invoices of the customer (FIG. 2, operation 258). Operation 258 may be performed by the invoice management module 106 and/or the invoice management server 160. An example of a pop-up window 310 in which the user 150 has selected multiple invoices for payment is shown in FIG. 3F. Upon selected all desired invoices, the user 150 may select a “Continue” button to continue to the invoice payment process.

The invoice management module 106 may receive the user 150's selection of one or more invoices via any of a variety of user interface mechanisms, such as any of the user interface mechanisms disclosed herein in connection with the user 150's selection of a single invoice in operation 208 (FIG. 2A). As one example, upon displaying the customer's open invoices in a pop-up window, the invoice management module 106 may present the user 150 with the option to select not just a single invoice but several invoices simultaneously. The user 150 may easily click on or otherwise indicate the desired invoices from the list displayed, in response to which the invoice management module 106 registers this selection in preparation for the subsequent payment processing step. This feature significantly streamlines the payment process for users who need to manage and settle multiple invoices for a customer, thereby enhancing the overall efficiency of the accounting tasks performed within the system 100.

The method 250 may also include receiving, from the user 150, an instruction to pay the selected invoices (FIG. 2B, operation 260). Operation 260 may be performed by the invoice management module 106 and/or the invoice management server 160. Operation 260 may generally be performed in any of the ways disclosed herein in connection with providing the pay instruction in operation 208 (FIG. 2A). This may include, for example, receiving input from the user 150 which updates the customer's payment method in any of the ways disclosed herein in connection with operation 208. FIG. 3G illustrates an example of a popup window 312 which includes a “Pay” button that the user 150 may select to provide the instruction to pay the selected invoices.

The method 250 may also include, in response to receiving the instruction to pay the selected invoices, causing the accounting software application 122 to record payments of the selected invoices (FIG. 2B, operation 262). Operation 262 may be performed by the invoice management module 106 and/or the invoice management server 160. Operation 262 may cause the accounting software application 122 to record payment of each of the selected invoices in any of the ways disclosed herein in connection with causing the accounting software application 122 to record a payment of a single invoice in operation 210 (FIG. 2A).

The invoice management module 106 may optionally provide output 156 to the user 150 to indicate a confirmation that the selected invoices have been paid. An example of such output 156 is shown in FIG. 3H in the form of a popup window 314 in which the selected invoices are shown as having been paid in full. Although not shown in FIG. 3H, such output 156 may also show that the balances of the paid invoices are now zero.

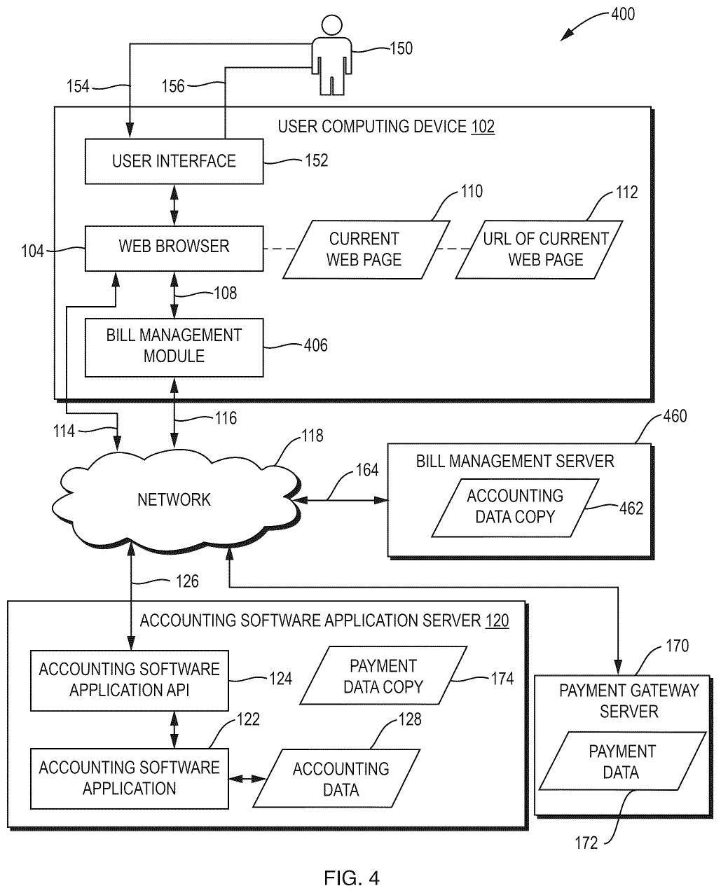

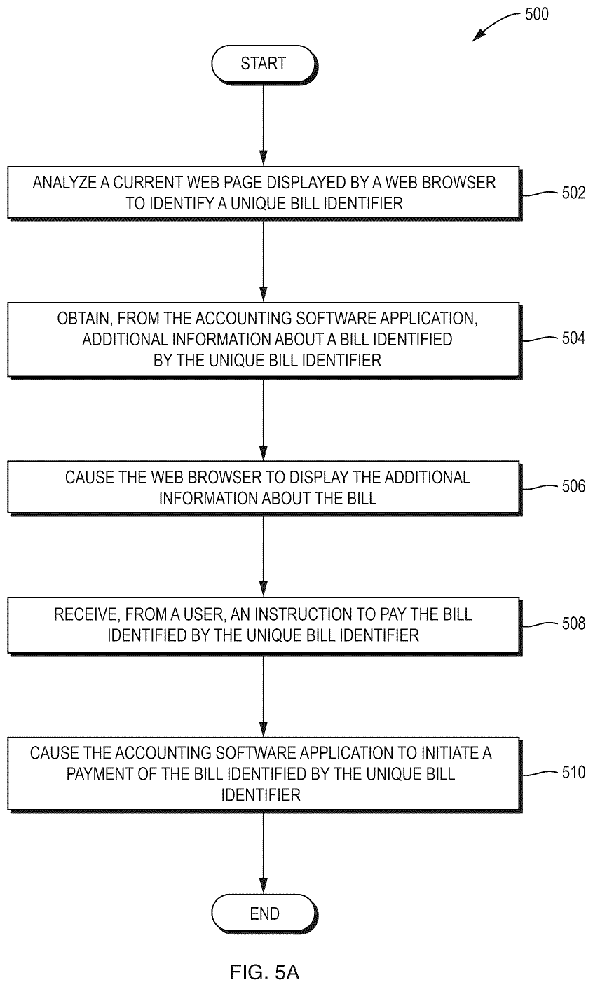

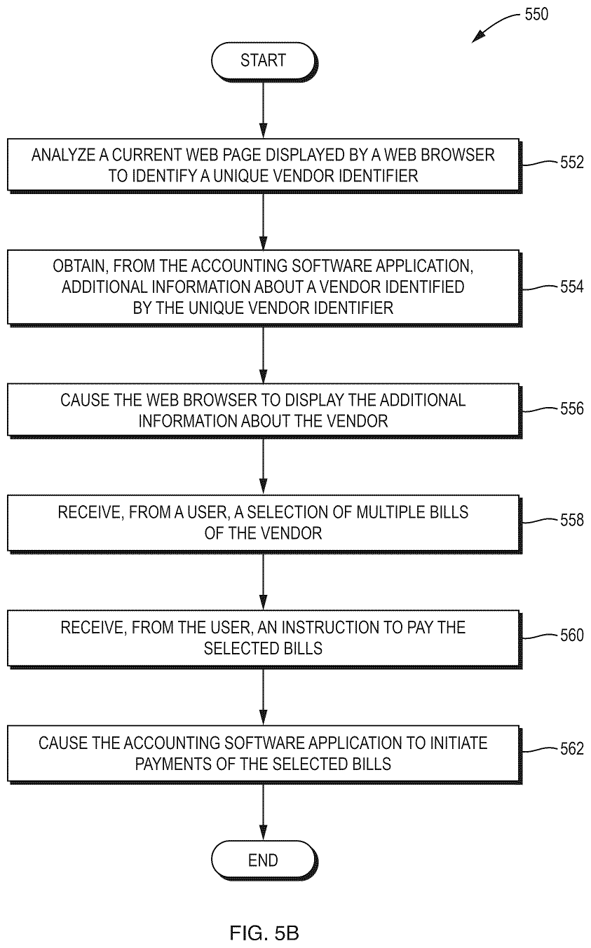

Embodiments of the present invention may enable a customer to pay one or more of the customer's bills with one or more vendors using techniques that are similar to those described above, as will now be described in more detail. Referring now to FIG. 4, a diagram is shown of a system 400 for processing a payment of a single customer bill according to one embodiment of the present invention. Referring now to FIG. 5A, a flowchart is shown of a method 500 performed by the system 400 of FIG. 4 to process a single bill according to one embodiment of the present invention.

The system 400 of FIG. 4 includes many of the same elements as the system 100 of FIG. 1. As will be described in more detail below, the system 400 may apply modified versions of the techniques disclosed above to enable the customer 150 to pay one or more of the customer 150's bills more easily and efficiently than was previously possible. It should be understood that any elements that are shown in both FIGS. 1 and 4, such as the user interface 152 and the web browser 104, may be implemented using a single element (such as a single user interface or a single web browser) that performs its functions disclosed herein in connection with both FIGS. 1 and 4. Alternatively, for example, it should be understood that any such elements may take different forms in the systems 100 and 400 of FIGS. 1 and 4, or even be implemented using different elements in the systems 100 and 400 of FIGS. 1 and 4. As one example, the user interface 152 of FIG. 4 may be part of a user interface within a single web application that provides functionality in both the system 100 of FIG. 1 and the system 400 of FIG. 4, but may include functionality that is tailored to perform the specific functions disclosed in connection with the system 400 of FIG. 4.

Because the systems 100 and 400 include a variety of elements either in common or that may be implemented in the same or similar ways, any features of the system 100 of FIG. 1 that are not explicitly disclosed herein in connection with the system 400 of FIG. 4 may be assumed to be capable of being implemented in the same or similar way in connection with FIG. 4. For example, for ease of explanation, although details about the network 118 may not be disclosed herein specifically in connection with the system 400 of FIG. 4, it may be assumed that any features of the network 118 that are disclosed herein in connection with FIG. 1 or otherwise are equally applicable to the system 400 of FIG. 4.

The system 400 of FIG. 4 includes many of the same elements as the system 100 of FIG. 1, adapted for bill management and payment by customers. For example, the user 150, input 154, output 156, user computing device 102, user interface 152, web browser 104, current web page, and URL of the current web page 112 function similarly to their counterparts in FIG. 1, but are now utilized in the context of managing and paying bills rather than processing invoices.

For example, the user 150 may be a customer or a person authorized to act on behalf of a customer, rather than a vendor. As another example, the current web page 110 displayed by the web browser 104 may now show bill details instead of invoice information, and the URL 112 may contain a unique bill identifier rather than a unique invoice identifier. The user 150 interacts with these elements through the user interface 152 to view, manage, and pay bills, providing input 154 and receiving output 156 related to bill processing. As with the system 100, these components work together to enable efficient bill management and payment, leveraging the existing infrastructure while adapting it to the specific needs of accounts payable processes.

The system 400 includes a bill management module 406, which is analogous to the invoice management module 106 in system 100 of FIG. 1. In fact, any features disclosed herein in connection with the invoice management module 106 are equally applicable to the bill management module 406, unless explicitly stated to the contrary herein. The bill management module 406 may reside within the user computing device 102 and perform various functions related to bill management and payment processing. A single software application or other component may implement both the invoice management module 106 and the bill management module 406.

Similar to its counterpart, the bill management module 406 may be implemented as a plugin, extension, or other kind of add-on to the web browser 104. However, it may also be implemented in other ways, such as a standalone application, an integrated feature within the web browser 104, a server-side application, or any combination thereof.

The bill management module 406 engages in various communications with the web browser 104 to perform its functions, which include obtaining information about outstanding bills, outputting such bill information to the user 150, and initiating payments of these bills. It interacts with the accounting software application 122 over the network 118 via the accounting software application API 124, transmitting and receiving communications to retrieve bill information and process payments.

During the onboarding process, the bill management module 406 may be configured with and store various information, such as details about the accounting software application 122, user identification information, and account credentials. This configuration allows the module 406 to automatically establish and maintain connections with the accounting software application 122 on behalf of the user 150, streamlining the bill management and payment process.

The bill management module 406 may also obtain and store relevant data from the user's accounting data 128, including information about the user 150, the user's vendors, the user's payment methods (e.g., one or more credit cards and/or bank accounts), and the user's outstanding bills. This local storage enables immediate access to relevant data when performing its functions, reducing the need for frequent data retrieval from the accounting software application 122.

By adapting the functionality of the invoice management module 106 to the context of bill management and payment, the bill management module 406 provides an efficient and user-friendly interface for managing accounts payable within the system 400.

The system 400 includes a bill management server 460, which serves as the counterpart to the invoice management server 160 in system 100. The bill management server 460 functions similarly to its invoice management counterpart but is tailored for bill management and payment processing.

Like the invoice management server 160, the bill management server 460 acts as an intermediary data repository and processing hub that interfaces with the user 150's local bill management module 406. It obtains and stores relevant data from the accounting software application 122, including information about the user 150's bills, vendors, and other accounts payable data. This information is stored in an accounting data copy 462, which is analogous to the accounting data copy 162 in the invoice management server 160.

The bill management server 460 synchronizes data with the accounting software application 122 over the network 118, ensuring that it maintains an up-to-date replica of the user 150's relevant accounting data. This synchronization process may occur periodically or as needed, reducing the need for frequent direct data retrieval from the accounting software application 122.

When the bill management module 406 requires access to the user 150's accounting data, it can send requests to the bill management server 460 instead of directly querying the accounting software application 122. The bill management server 460 processes these requests by retrieving the necessary data from the accounting data copy 462 and providing it to the bill management module 406. This approach minimizes latency and network load, resulting in faster response times and a more fluid user experience.

It is important to note that a single server may implement both the invoice management server 160 and the bill management server 460. This unified approach allows for efficient resource utilization and seamless integration of accounts receivable and accounts payable functionalities within the same system.

Referring to FIG. 5A, a flowchart is shown of a method 500 performed by the system 400 of FIG. 4 according to one embodiment of the present invention. Assume that, before the method 500 begins, the user 150 has already used the web browser 104 to navigate to the current web page 110. The URL 112 is the URL of the current web page 110. Further assume that the current web page 110 is a web page that has been served by the accounting software application server 120, and which displays an open bill from a vendor within the accounts payable of the user 150's account with the accounting software application 122.

The method 500 includes analyzing the current web page 110 displayed by the web browser 104 to identify a unique bill identifier (FIG. 5A, operation 502). Operation 502 may, for example, be performed by the bill management module 406, which, as described elsewhere herein, may be implemented as a plugin to the web browser 104. As will be described in more detail below, the unique bill identifier is subsequently used to retrieve additional bill information and to facilitate payment of the bill identified by the unique bill identifier.

Note that the unique bill identifier identified by the method 500 in operation 502 may or may not be the bill identifier that the accounting software application 122 displays to the user 150 to identify the corresponding bill. For example, in connection with any particular bill, the accounting software application 122 may create and store a unique bill identifier for internal purposes. This unique bill identifier may, for example, be created by the accounting software application 122 at the time of creating the bill and may not change over time. In addition, the accounting software application 122 may create and store an additional unique bill identifier, referred to herein as the “user bill identifier,” which may or may not be the same as the unique bill identifier.

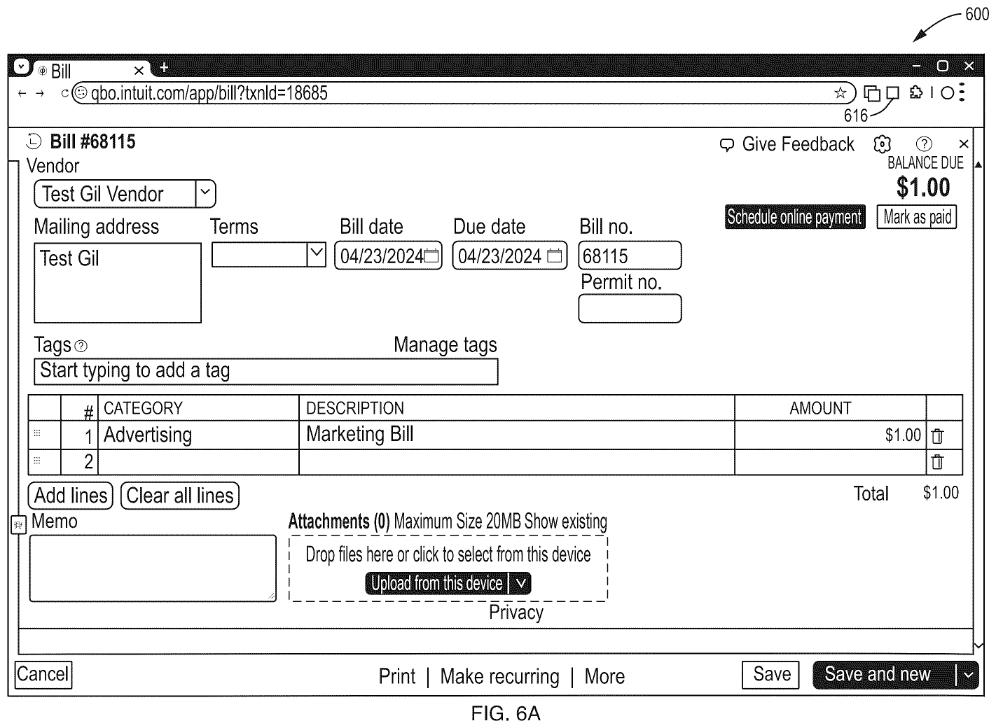

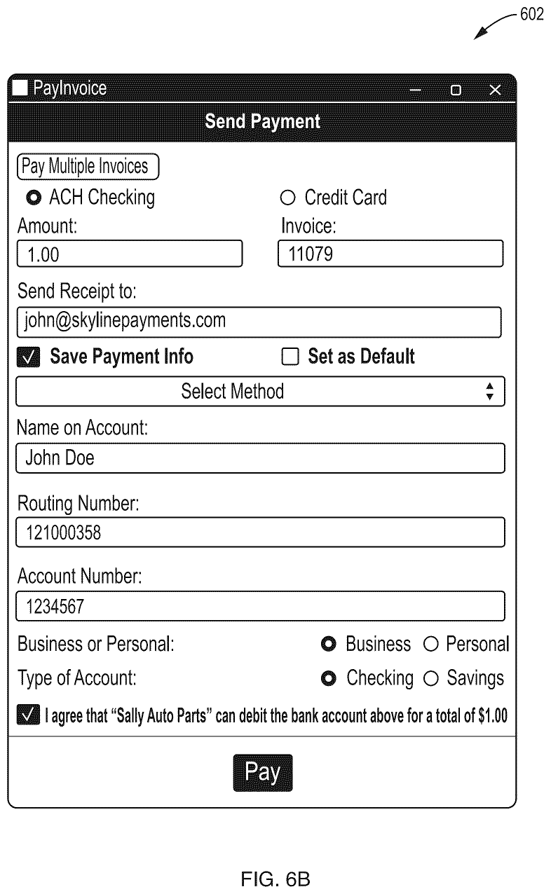

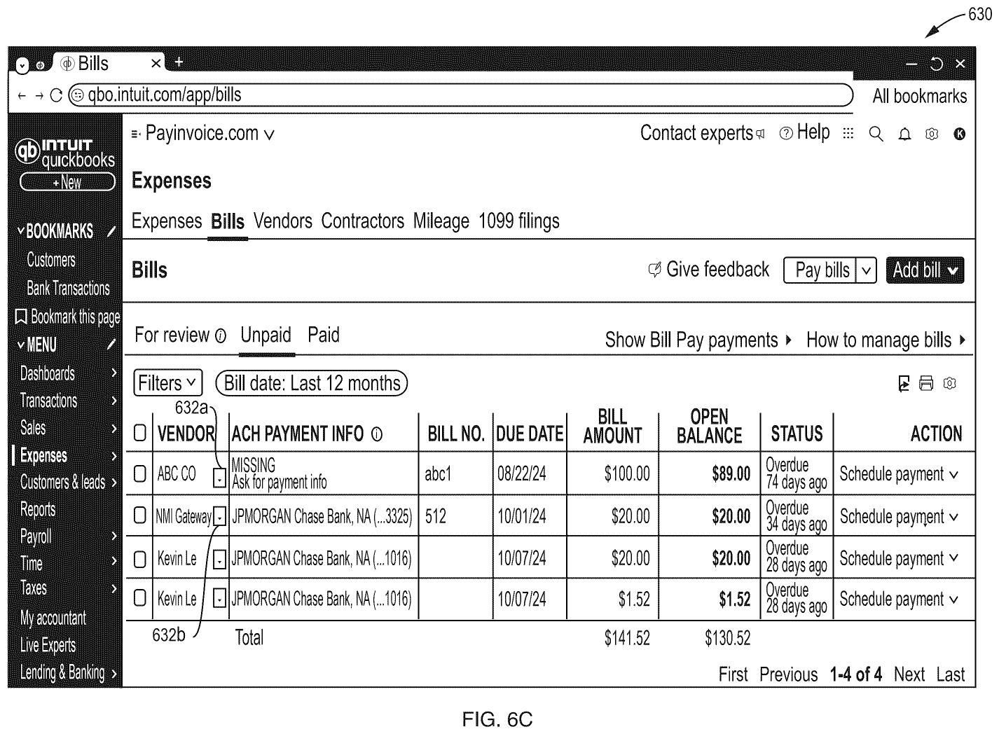

For example, referring to FIG. 6A, a diagram is shown of an example web page 600 displayed by the web browser 104 at the time of operation 502 according to one embodiment of the present invention. In the example of FIG. 6A, the web page 600 displays information about a bill that is open in the user 150's accounting data 128 in the accounting software application 122. The web page 600 may, for example, be a conventional web page that is displayed by the accounting software application 122 via the web browser 104 to display information about an open bill in the user 150's accounting data 128. As can be seen in FIG. 6A, the web page 600 includes a variety of information about the open bill, such as the user bill number, terms, bill date, due date, and vendor details. The particular structure, content, and layout of the web page 600 shown in FIG. 6A are merely examples and do not constitute limitations of the present invention.

In the web page 600 of FIG. 6A, the unique bill identifier can be seen from the URL of the current web page 110 to be 18685, while the user bill identifier, which is displayed in the text field labeled “Bill No.”, can be seen to be 68115. As this example illustrates, the unique bill identifier may not be the same as the user bill identifier.

If the user 150 changes the user bill identifier (e.g., to a different value), the unique bill identifier may remain the same. The user 150 may store a mapping between the unique bill identifier and the user bill identifier in the accounting data 128, which enables the accounting software application 122 to look up the user bill identifier based on the unique bill identifier, and to look up the unique bill identifier based on the user bill identifier.

Although, as just described, the unique bill identifier and the user bill identifier may (and often do) differ from each other, this is not a requirement of the present invention. Alternatively, for example, the unique bill identifier and the user bill identifier may have the same value as each other. As another example, the accounting software application 122 may only maintain the unique bill identifier, and may use that unique bill identifier to perform the functions of the user bill identifier as well, such as by displaying the unique bill identifier within web pages and other user interfaces (e.g., within the “Bill no.” field of the web page 600 of FIG. 6A).

Operation 502 may include analyzing any of a variety of aspects of the current web page 110 to identify the unique bill identifier. For example, the method 500 may analyze the URL 112 of the current web page 110 to identify the unique bill identifier. As another example, the method 500 may analyze one or more user interface elements of the current web page 110 to identify the unique bill identifier. As a particular example, the method 500 may analyze a text field on the current web page 110 to identify the unique bill identifier within that text field. Any reference herein to analyzing the current web page 110 to identify the unique bill identifier should be understood to include analyzing the URL 112 of the current web page and/or one or more user interface elements of the current web page 110 to identify the unique bill identifier.

Other examples of information within or related to the current web page 110 that the method 500 may analyze in operation 502 to identify the unique bill identifier include any one or more of the following, in any combination:
Textual content of the current web page 110, such as visible text that may include bill numbers, vendor names, or other identifying information.
HTML Tags: Specific tags (e.g., <span>, <div>, <p>) that might contain data attributes or text associated with the unique bill identifier.
Form Fields: Input fields, hidden fields, or other form elements that may contain information that the method 500 may use to identify the unique invoice identifier.
JavaScript Variables: Variables within scripts on the current web page 110 that store the unique bill identifier and/or information that may be used to identify the unique bill identifier.
Embedded Objects: Embedded PDFs, images, or other objects that may include the unique bill identifier and/or information that may be used to identify the unique bill identifier.
The URL of the current web page 110, which may include query parameters, path segments, and/or URL fragments.
Webpage Metadata, such as meta tags, structured data, Open Graph tags, and/or canonical tags.
HTTP Headers: Response headers from the server that may include custom headers.
Cookies: Cookies set by the website that could store session-specific bill identifiers.
API Responses: Data returned from API calls made by the current web page 110, which could include JSON or XML structures with bill identifiers.
Browser History: The browser's history object that could contain URLs of previously visited bill pages.
Cache Data: Cached data from previous interactions with the bill page that might store identifiers.

As another example, the method 500 may analyze one or more images of the current web page 110, as rendered by the web browser 104, to identify the unique bill identifier. The method 500 may, for example, analyze one or more images of the current web page 110 to identify the unique bill identifier using the same or similar techniques as those described above in connection with identifying unique invoice identifiers. As a result, those techniques will not be described again here. This image analysis capability allows the system 400 to extract the unique bill identifier from graphical representations of the web page 110, including situations where the bill identifier may be embedded within visual elements or presented in a non-textual format.

For example, the method 500 may employ various image analysis techniques, such as Optical Character Recognition (OCR), to identify the unique bill identifier based on one or more renderings of the current web page 110. Additionally, the system may utilize Al-based techniques, including models trained using machine learning, to analyze the current web page 110 and identify the unique bill identifier.

To facilitate this identification process, the system 400 may be equipped with the capability to automatically capture one or more images of the rendered current web page 110. These captured images may then be analyzed using the techniques described above in connection with invoice identifier identification to identify the unique bill identifier, even if the web browser 104 has navigated to a different page or is no longer executing. As this implies, the system 400 and method 500 may identify the unique bill identifier based on one or more images that are not currently being displayed by the web browser 104, and which therefore do not constitute a “current” web page. As this implies, any reference herein to the current web page 110 should be understood to encompass not only “current” web pages, but any images of currently- or previously-displayed web pages, and other image and non-image information derived from such web pages, whether or not such web pages or the information derived therefrom are currently displayed.

The bill management module 406 may initiate the analysis of the current web page 110 (e.g., the URL 112 of the current web page 110 and/or one or more user interface elements of the current web page 110) in operation 502 in response to any of a variety of triggers. For example, the user 150 may provide input 154 to the bill management module 406, in response to which the bill management module 406 may perform operation 502. As a particular example, the user 150 may select a user interface element displayed by the web browser 104. An example of such a user interface element is a button associated with a web browser plugin that implements the bill management module 406. An example of such a button 616 is shown in the upper right corner of the web page 600 of FIG. 6A.

The user 150 may press that button 616, in response to which the bill management module 406 may perform operation 502. As this example illustrates, the bill management module 406 may perform operation 502 in response to as little as a single input (e.g., a selection of or other interaction with a single user interface element) by the user 150.

The bill management module 406 may analyze the current web page 110 using various methods to identify the unique bill identifier, which may be the same as or similar to those described above for identifying unique invoice identifiers. These methods may include, for example, analyzing the current web page 110 for specific patterns or character sequences that precede, follow, or encapsulate the unique bill identifier within different features of the web page (e.g., URL, images, or user interface elements). The bill management module 406 may, for example, employ pattern matching algorithms preconfigured with knowledge of the accounting software application 122's structure and syntax for embedding bill identifiers. These algorithms may, for example, parse the current web page 110 to detect predetermined strings or delimiters that signal the start and end of the unique bill identifier. Once identified, the bill management module 406 may isolate the unique bill identifier-a distinctive sequence of numbers, letters, or a combination thereof-which the accounting software application 122 assigns to each bill for unambiguous identification. For further details about how the bill management module 406 may analyze the current web page 110 to identify the unique bill identifier, see the description herein of how the invoice management module 106 may analyze the current web page 110 to identify the unique invoice identifier.

The system 400 and method 500 may be used with various accounting software applications, similar to the system 100 and method 200 disclosed above in connection with invoice identifiers. For example, the bill management module 406 may be configured to work with different accounting software applications (e.g., QuickBooks Online, Freshbooks) that use distinct formats for encoding unique bill identifiers within web pages. Each accounting software application may have its own method of embedding or encoding unique bill identifiers in URLs or user interface elements. The bill management module 406 may be configured with different pattern matching algorithms tailored to these distinct text string patterns.

When analyzing the current web page 110 in operation 502, the bill management module 406 may identify the specific accounting software application being used and select the appropriate pattern matching algorithm for that application. This allows the module to use different algorithms or patterns to identify unique bill identifiers depending on the accounting software application in use. For example, the bill management module 406 might use one pattern matching algorithm to identify unique bill identifiers in web pages from a first accounting software application, and a different algorithm for a second accounting software application.

More generally, the bill management module 406 may use any of the techniques disclosed herein in connection with the invoice management module 106's for identifying unique invoice identifiers to identify unique bill identifiers.

The method 500 also includes obtaining, from the accounting software application 122, additional information about a bill identified by the unique bill identifier (FIG. 5A, operation 504). Operation 504 may, for example, be performed by the bill management module 406. The bill management module 406 may obtain the additional information about the bill from the accounting software application 122 using any suitable communications 116 and 126 between the bill management module 406 and the accounting software application 122, via the accounting software application API 124.

The bill management module 406 may initiate a request to the accounting software application 122 via the accounting software application API 124, including the unique bill identifier as a parameter. This instructs the accounting software application 122 to return data associated with that specific bill. Upon receiving the request, the accounting software application 122 may query the accounting data 128 (e.g., the accounts payable portion of the user 150's account) to locate the bill corresponding to the provided unique bill identifier. The accounting software application 122 then extracts the requested bill information from the accounting data 128, and transmits the extracted information back to the bill management module 406 over the network 118 via the accounting software application API 124. This information may include, for example, vendor information, bill details (e.g., bill identifier, date of issue, due date, description of goods or services, amounts), and payment information (e.g., payment status, terms, history, remaining balance). For additional details on interactions between the bill management module 406 and the accounting software application 122, refer to the corresponding explanation above in connection with the system 100 of FIG. 1 and the method 200 of FIG. 2.

The method 500 may further include causing the web browser 104 to display the additional information about the bill (FIG. 5A, operation 506). Operation 506 may be performed by the bill management module 406 and/or the bill management server 460. Displaying the additional information about the bill enhances the user experience by providing immediate access to comprehensive bill details directly within the web browsing environment. The bill management module 406 may cause the web browser 104 to display the additional information about the bill in various ways, such as any one or more of the following: pop-up window, sidebar panel, dedicated tab or window, in-page overlay, interactive notification, dynamic content injection, or responsive design.

FIG. 6B shows an example of an embodiment in which the bill management module 406 displays the additional information about the bill in the form of a pop-up window 602. In the example of FIG. 6B, the pop-up window 602 is shown as overlaying the web page 600 that displays the bill details. The pop-up window 602 includes a variety of information, such as the bill number, amount due, vendor email address, user interface elements for displaying and/or editing the user 150's payment method, and a “Pay” button. The particular structure, content, and layout of the pop-up window 602 shown in FIG. 6B are merely examples and do not constitute limitations of the present invention.

Recall that the system 400 may analyze the current web page 110 and/or a rendering of the current web page 110 to identify one or more unique bill identifiers within the current web page 110 and/or the rendering of the current web page 110. Once the system 400 has analyzed the current web page 110 and/or a rendering of the current web page 110 to identify one or more unique bill identifiers within the current web page 110 and/or the rendering of the current web page 110, the system 400 may modify the current web page 110 and/or the rendering of the current web page 110 to provide, for each identified unique bill identifier, a corresponding user interface element that may be selected by the user 150 to trigger operations 504 and/or 506.

The system 400 and method 500 may, for example, include a user interface that is analogous to that shown in FIG. 3J, but for use with bills rather than invoices. The system 400 may be adapted to display information about multiple bills, each with its unique bill identifier, in a manner similar to how invoices are displayed in FIG. 3. For example, the system 400 may modify the current web page 110 to include user interface elements (such as buttons) associated with each unique bill identifier. These elements may be placed adjacent to or near the corresponding bill identifiers.

When the user 150 selects one of these user interface elements, the system 400 may identify the associated unique bill identifier and perform operations 504 and/or 506 in connection with that bill. This functionality allows for quick access to bill details or payment options directly from the list of bills. The user interface elements for bills may be implemented in various ways, similar to those described for invoices in connection with the system 100 of FIG. 1 and the method 200 of FIG. 2. For example, they could be buttons, hyperlinks, or modifications to the appearance of the bill identifier itself (e.g., highlighting, bolding, or changing the font or color). The system 400 may dynamically insert these user interface elements into the current web page 110 or its rendering, even if the original version of the current web page 110 does not include such elements. This insertion may occur after the system 400 identifies the unique bill identifiers using the techniques described earlier. While this functionality is particularly useful for web pages containing multiple unique bill identifiers, the system 400 may implement it even for pages with only a single bill identifier.

The system 400 may include a user interface that is analogous to that shown in FIG. 3K, but for use with bills rather than invoices. In this context, the system 400 may implement similar functionality to trigger operations 504 and/or 506, which are analogous to operations 204 and 206 in the method 200 of FIG. 2.

For example, the current web page 110 in the system 400 may contain text including a unique bill identifier, such as “Bill 68115”. The user 150 may provide “menu triggering input” in connection with this displayed unique bill identifier, such as by right-clicking or Control-clicking on the rendering of the unique bill identifier. In response to this menu triggering input, the system 400 may display a contextual menu. This menu might include a payment triggering menu item, such as a “Pay Bill” option, associated with the selected unique bill identifier.

If the user 150 selects this payment triggering menu item, the system 400 may then perform operations 504 and/or 506 in connection with the associated unique bill identifier. These operations may include obtaining additional information about the bill and displaying this information to the user.

This process represents another way for the system 400 to identify a unique bill identifier to use within the method 500, analogous to how the method 200 identifies unique invoice identifiers This functionality may be implemented in various user interfaces within the system 400, not just in a specific layout. For instance, the system 400 may apply this contextual menu approach to interfaces displaying multiple unique bill identifiers.

The method 500 may also include receiving, from the user 150, an instruction to pay the bill identified by the unique bill identifier (FIG. 5A, operation 508). Operation 508 may be performed by the bill management module 406 and/or the bill management server 460.

The bill management module 406 may receive the user 150's instruction to pay via any of a variety of user interface mechanisms, such as: payment button, interactive form, voice command, gesture control, keyboard shortcut, confirmation dialog, payment links, API-driven payment, and/or biometric authentication. Each of these implementations provides a different method for the user 150 to convey their payment instruction, catering to diverse user preferences and ensuring that the payment process is both user-friendly and secure. The bill management module 406 may be designed to accommodate various user interactions, making the payment process as intuitive and efficient as possible.

Before providing the instruction to pay the bill, the user 150 may input information about the payment method to be used. The additional bill information displayed in operation 506 may include information about a payment method associated with the vendor, such as the vendor's preferred payment method. This payment method information may be displayed within the same user interface element as the additional bill information.

The bill management module 406 may allow the user 150 to review, approve, and/or edit the payment information before proceeding with the payment instruction. When displaying the bill details in operation 506, the bill management module 406 may also show the vendor's preferred payment method, which may, for example, be a credit card, bank account, or other payment option associated with the vendor's account in the accounting software application 122.

The user interface 152 may allow the user 150 to interact with the displayed payment information to review and confirm the vendor's preferred payment method. The user 150 may approve the payment method through a simple confirmation action or by proceeding with the payment instruction, which implies approval.

If changes to the payment method are needed, the user 150 may select an “Edit” option to modify payment details such as credit card information or bank account selection. After making any necessary edits, the user 150 may save the updated payment information, which the bill management module 406 then saves to the user 150's account in the accounting data 128 via the accounting software application 122.

Issuing a payment instruction may be interpreted as both saving any payment method updates and authorizing payment using the updated information. The accounting software application 122 may then use this updated payment method information to process the bill payment.

The method 500 may also include, in response to receiving the instruction to pay the bill identified by the unique bill identifier, causing the accounting software application 122 to initiate a payment of the bill identified by the unique bill identifier (FIG. 5A, operation 510). Operation 510 may be performed by the bill management module 406 and/or the bill management server 460.

It is important to note that, in the system 400 of FIG. 4, the user 150 may be the customer or a representative of the customer. As a result, the user 150 may have authority to initiate the actual payment, and the system 400 may therefore take a more active role in the payment process than the system 100 of FIG. 1. For example, rather than simply recording the payment, the system 400 may actively initiate the payment process through the accounting software application 122. The accounting software application 122 in the system 400 of FIG. 4 may interface with payment processing systems and/or banks to execute the payment, rather than just recording it internally. The payment in the system 400 of FIG. 4 may be initiated immediately upon receiving the user 150's instruction.

In response to receipt of the user 150's instruction to pay the bill, the bill management module 406 may communicate with the accounting software application 122 to initiate the payment of the bill associated with the unique bill identifier. This process can be implemented through various methods that go beyond simply recording the payment.

For example, the bill management module 406 may make an API call to the accounting software application 122 via the accounting software application API 124, sending a request that includes the unique bill identifier and payment details such as the amount, payment method, and date. The accounting software application 122 then processes the request and initiates the actual payment, including updating the accounting data 128 accordingly and interfacing with the necessary payment systems or banks to execute the transaction.

Alternatively, the bill management module 406 may simulate the submission of a payment form within the accounting software application 122's user interface, auto-filling the necessary fields with the bill identifier and payment information before programmatically submitting the form to initiate the payment process. If the bill management module 406 has direct access to the accounting data 128, it can execute a database command to update the bill record with the payment details and trigger the payment initiation process.

Alternatively or additionally, the bill management module 406 may integrate with a payment processor that not only confirms the payment but actually executes it, communicating with the accounting software application 122 to update the bill status and initiate the fund transfer in real-time. As this implies, the bill management module 406 may have the capability to initiate payments and/or cause payments to be initiated independently of the accounting software application 122. This functionality expands the flexibility and efficiency of the system 400 and method 500. A variety of ways in which the bill management module 406 may accomplish this include the following:
Direct integration with payment gateways: The bill management module 406 may establish direct connections with various payment gateways or financial institutions. This allows it to initiate payments by sending payment instructions directly to these services, bypassing the accounting software application 122 entirely.
Automated Clearing House (ACH) transactions: The module 406 may be configured to generate and submit ACH files directly to the user 150's bank, initiating electronic fund transfers without involving the accounting software application 122.
Virtual card payments: The bill management module 406 may generate virtual credit card numbers for one-time use and submit payment to vendors using these virtual cards, handling the entire process independently.
API integrations with financial institutions: By leveraging APIs provided by banks or financial institutions, the module 406 may initiate wire transfers or other forms of electronic payments directly.
Blockchain or cryptocurrency payments: For vendors accepting digital currencies, the bill management module 406 may initiate cryptocurrency transactions through appropriate blockchain networks, completely separate from traditional accounting software functions.
Mobile payment integrations: The module 406 may integrate with mobile payment platforms to initiate payments, particularly useful for users managing bills on mobile devices.
Batch payment processing: The bill management module 406 may aggregate multiple bills and initiate a single batch payment through a preferred payment method, optimizing the payment process without relying on the accounting software application 122.

By implementing these methods, the bill management module 406 can offer more rapid, flexible, and potentially cost-effective payment options compared to relying solely on the accounting software application 122. This independence allows for quicker adoption of new payment technologies and methods as they emerge.

Even if the bill management module 406 initiates a payment independently, the bill management module 406 may still communicate the payment details back to the accounting software application 122 to ensure proper record-keeping and synchronization of financial data. This communication may be done through any of the mechanisms disclosed herein, such as API calls, database updates, or other integration methods as previously described.

The bill management module 406 may optionally provide output 156 to the user 150 to indicate a confirmation that the bill has been paid. An example of such output 156 could be in the form of a web page in which the bill is shown as having been paid in full. Such output 156 may also show that the balance of the paid bill is now zero. Additionally, the confirmation output may include details such as the payment date, payment method used, and any transaction reference numbers associated with the payment. This information helps the user 150 verify that the payment has been successfully processed and provides a record for future reference. The confirmation output 156 may also include information about the actual fund transfer, such as the estimated time for the payment to be received by the vendor or any relevant payment processing details.

A second embodiment of the present invention provides a method for managing and processing one or more open bills for the user/customer 150 within the user 150's accounting data 128 in the accounting software application 122. This second embodiment will now be described. Various aspects of this second embodiment operate in the same or similar manner to the first embodiment, in which a single displayed bill is processed for payment. As a result, the following description will focus on aspects of the second (customer-based) embodiment, and it should be assumed that any aspects of the second embodiment that are not described below may be implemented in any of the ways disclosed herein in connection with the first (bill-based) embodiment.

This embodiment allows the system 400 and method 500 to display multiple open bills for the user 150, enabling them to select and process multiple bills for payment simultaneously. This functionality can significantly streamline the accounts payable process for the user 150, providing a more efficient way to manage and pay multiple bills at once. The approach in this embodiment is similar to how the system 100 (FIG. 1) and method 200 (FIG. 2) handle multiple invoices, but it is adapted for the accounts payable context.

Referring to FIG. 5B, a flowchart is shown of a method 550 performed by the system 400 of FIG. 4 according to the second embodiment of the present invention. Assume that, before the method 550 begins, the user 150 has already used the web browser 104 to navigate to the current web page 110. Further assume that the current web page 110 is a web page that has been served by the accounting software application server 120, and which displays information about a particular vendor within the accounts payable of the user 150's account with the accounting software application 122. Such information may include, for example, information about a plurality of open bills from the vendor within the accounts payable section of the user 150's accounting data 128 in the accounting software application 122.

The method 550 includes analyzing the current web page 110 displayed by the web browser 104 (e.g., the URL 112 and/or within one or more user interface elements of the current web page 110) to identify a unique vendor identifier (FIG. 5B, operation 552). Operation 552 may, for example, be performed by the bill management module 406, which, as described elsewhere herein, may be implemented as a plugin to the web browser 104. As will be described in more detail below, the unique vendor identifier is subsequently used to retrieve additional vendor information and to facilitate payment of one or more of the vendor's open bills.

FIG. 6C illustrates an example of a web page 630 displaying multiple bills, analogous to the web page 330 that is shown in FIG. 3J. Such a web page 630 may, for example, display unique bill identifiers for a plurality of the vendor's bills (including both open and closed bills), especially bills that are addressed to the user 150 or a customer associated with the user 150. The particular structure, content, and layout of such a web page are examples and would not constitute limitations of the present invention.

For example, the example web page 630 of FIG. 6C displays information about a plurality of bills, having unique bill identifiers “abc1” and “512”. In the web page 630 of FIG. 6C, the system 400 has modified the web page 630 to include: (1) a first user interface element 632a (e.g., a button) that is associated with (e.g., adjacent to) the first unique bill identifier (“abc1”); and (2) a second user interface element 632b that is associated with (e.g., adjacent to) the second unique bill identifier (“512”).

The user 150 may provide input selecting the first user interface element 632a, in response to which the system 400 may identify, in the web page 630, the unique bill identifier (“abc1”) that is associated with the first user interface element 632a, and perform operations 204 and/or 206 in connection with the first unique bill identifier. Similarly, the user 150 may provide input selecting the second user interface element 632b, in response to which the 100 may identify, in the web page 630, the unique bill identifier (“512”) that is associated with the second user interface element 632b, and perform operations 504 and/or 506 in connection with the first unique bill identifier. Note that the web page 630 may include the first user interface element 632a and the second user interface element 632b instead of, or in addition to, the page-wide button 616 shown in FIG. 6A.

Such user-specific user interface elements (e.g., the buttons 632a and 632b) may be inserted dynamically into the current web page 110, and/or into a rendering of the current web page 110, by the system 400. For example, the original version of the current web page 110 may lack such user interface elements, and the system 400 may insert into the current web page 110, for each unique bill identifier that the system 400 identifies in the current web page 110 using any of the techniques disclosed herein (such as by analyzing a rendering of the current web page 110), a corresponding user interface element.

The bill management module 406 may initiate the analysis of the current web page 110 in operation 552 in response to any of a variety of triggers. For example, the user 150 may provide input 154 to the bill management module 406, such as by pressing the web browser plug-in button previously described, in response to which the bill management module 406 may perform operation 552.

The bill management module 406 may analyze the current web page 110 in any of the ways disclosed above in connection with analyzing the current web page 110 to identify the unique bill identifier, but instead to identify the unique vendor identifier. The bill management module 406 may, for example, employ a pattern matching algorithm that has been preconfigured with knowledge of the structure and syntax used by the accounting software application 122 to embed vendor identifiers within web pages (e.g., URLs and/or user interface elements, such as text fields). This algorithm may parse the current web page 110 (e.g., the URL 112 and/or one or more user interface elements of the current web page 110) to detect the presence of predetermined strings (e.g., delimiters) that signal the start and end points of the unique vendor identifier.

The method 550 also includes obtaining, from the accounting software application 122, additional information about the vendor identified by the unique vendor identifier (FIG. 5B, operation 554). Such additional information about the vendor may include, for example, non-bill information about the vendor (such as the vendor's name and address) and/or bill-specific information about the vendor (such as information about a plurality of open bills from the vendor within the accounts payable section of the user 150's accounting data 128 within the accounting software application 122).

Operation 554 may, for example, be performed by the bill management module 406. The bill management module 406 may obtain the additional information about the vendor from the accounting software application 122 using any suitable communications 116 and 126 between the bill management module 406 and the accounting software application 122, via the accounting software application API 124.

The method 550 may further include causing the web browser 104 to display the additional information about the vendor (FIG. 5B, operation 556). Operation 556 may be performed by the bill management module 406 and/or the bill management server 460. Displaying the additional information about the vendor may include, for example, displaying non-bill information about the vendor (such as the vendor's name and address) and/or bill-specific information about the vendor (such as information about a plurality of open bills from the vendor within the accounts payable section of the user 150's accounting data 128 within the accounting software application 122).

The display of the additional information about the vendor may, for example, take any of the forms disclosed herein in connection with the display of the additional bill information. As a particular example, a pop-up window or modal dialog box can be generated by the bill management module 406, overlaying the display of the current web page 110 in the output 156 of the user interface 152. This window may be designed to present the additional vendor information in an organized and easily readable format, allowing the user 150 to review details without navigating away from the current page.

The method 550 may also include receiving, from the user 150, a selection of one or multiple bills within the plurality of open bills from the vendor (FIG. 5B, operation 558). Operation 558 may be performed by the bill management module 406 and/or the bill management server 460.

The bill management module 406 may receive the user 150's selection of one or more bills via any of a variety of user interface mechanisms, such as any of the user interface mechanisms disclosed herein in connection with the user 150's selection of a single bill in operation 508 (FIG. 5A). As one example, upon displaying the vendor's open bills in a pop-up window, the bill management module 406 may present the user 150 with the option to select not just a single bill but several bills simultaneously. The user 150 may easily click on or otherwise indicate the desired bills from the list displayed, in response to which the bill management module 406 registers this selection in preparation for the subsequent payment processing step. This feature significantly streamlines the payment process for users who need to manage and settle multiple bills from a vendor, thereby enhancing the overall efficiency of the accounting tasks performed within the system 400.

The method 550 may also include receiving, from the user 150, an instruction to pay the selected bills (FIG. 5B, operation 560). Operation 560 may be performed by the bill management module 406 and/or the bill management server 460. Operation 560 may generally be performed in any of the ways disclosed herein in connection with providing the pay instruction in operation 508 (FIG. 5A). This may include, for example, receiving input from the user 150 which updates the vendor's payment method in any of the ways disclosed herein in connection with operation 508.

**The bill management module 406 may allows the user 150 to schedule payments for a future date. When instructing the system 400 to pay a bill, the user 150 (e.g., customer) may specify a future payment date, such as on or shortly before the bill's due date. This feature enables better cash flow management and ensures timely payments without the need for manual intervention on the actual due date.

The method 550 may also include, in response to receiving the instruction to pay the selected bills, causing the accounting software application 122 to initiate payments of the selected bills (FIG. 5B, operation 562). Operation 562 may be performed by the bill management module 406 and/or the bill management server 460. Operation 562 may cause the accounting software application 122 to initiate payment of each of the selected bills in any of the ways disclosed herein in connection with causing the accounting software application 122 to initiate a payment of a single bill in operation 510 (FIG. 5A).

The bill management module 406 may optionally provide output 156 to the user 150 to indicate a confirmation that the selected bills have been paid. The system 400 may, for example, include a similar popup window to that of FIG. 3H, in which the selected bills are shown as having been paid in full. Such output 156 may also show that the balances of the paid bills are now zero.

Embodiments of the present invention have a variety of advantages, such as one or more of the following.

For example, prior art systems often involve a cumbersome and manual process for managing and paying invoices, which can lead to several drawbacks, such as time-consuming payment processes involving multiple steps to view, manage, and pay invoices, including navigating through various screens or menus, manually entering payment details, and confirming transactions separately. Such tedious processes, involving significant amounts of manual data entry and navigation, increase the likelihood of human error, such as incorrect payment amounts, misapplied payments, or the use of outdated payment methods. Furthermore, prior art systems may often are not well-integrated, necessitating the use of separate platforms for viewing invoices, processing payments, and updating accounting records, leading to inefficiencies and potential discrepancies. Users may find it difficult to quickly access all relevant invoice information in one place when using such prior art systems, potentially leading to frustration and delays in the payment process. Prior art systems may not be designed for use across different devices or browsers, limiting user access to the system and the ability to manage invoices on-the-go. Such systems also scale poorly; as the volume of invoices increases, the manual and multi-step processes of prior art systems can become unmanageable and may not scale well with the growth of a business.

Embodiments of the present invention address these drawbacks through several key features. For example, embodiments of the present invention simplify the process of invoice payment by allowing users to view and pay invoices with fewer steps, directly within the web browser, and while remaining on the website of the accounting software application. This reduces the time spent on invoice management and payment processing. For example, in prior art systems, if the user is viewing an invoice or a customer on a webpage of the accounting software application and wishes to process an invoice payment using an invoice management application, the user typically must perform multiple steps, such as navigating to a webpage of the invoice management application, selecting an option to search by invoice number, inputting a desired invoice number and performing a search, selecting an invoice from the search results, inputting payment details, and submitting payment instructions. In comparison, embodiments of the present invention enable the user 150 to process payment of an invoice while remaining on the webpage of the accounting software application and without, for example, navigating to a separate webpage or logging into a separate application. Instead, as described elsewhere herein, the user may process an invoice payment right from the accounting software application webpage on which the invoice or customer information is being displayed, using the simple steps disclosed herein. This simplified process, which is aided by the system 100's automated onboarding process and retrieval of invoice details from the user 150's accounting data 128, not only greatly increases the efficiency of the invoice payment process, which can result in a significant reduction in time required, especially when the user 150 pays a large number of invoices, but also avoids taking the user's attention away from the current webpage of the accounting software application, which enables the user to remain focused on his or her existing workflow.

By automatically extracting invoice information from the current web page and using it to retrieve and display invoice details, embodiments of the present invention minimize the risk of human error associated with manual data entry. Embodiments of the present invention interface with various accounting systems and can be implemented as a web browser plugin, providing a single, integrated solution for managing and paying invoices. Embodiments of the present invention present all relevant invoice information in an easy-to-understand format, such as a pop-up window, improving the overall user experience and making it easier to review and process payments. Embodiments of the present invention which are implemented using a web browser plugin can be designed to work across different web browsers and devices, offering greater accessibility and convenience for users who need to manage invoices from various locations. The automated and integrated nature of embodiments of the present invention allow it to handle a growing number of invoices efficiently, making it well-suited for businesses experiencing growth and an increased volume of transactions. In summary, by addressing the limitations of prior art systems, embodiments of the present invention provide a more efficient, accurate, and user-friendly approach to invoice management and payment processing.

The system 400 (FIG. 4) and method 500 (FIG. 5), which focus on streamlining the bill payment process by the user 150 (e.g., customer), offer several specific advantages beyond those described for the vendor-side system 100 (FIG. 1) and method 200 (FIG. 2). For example, by streamlining the bill payment process, the system 400 allows businesses to better manage their cash flow. Users can easily view and select multiple bills for payment, enabling them to strategically time payments based on due dates and available funds. This efficient processing of bills can lead to improved relationships with vendors, potentially resulting in better terms, discounts, or priority service.

The automated bill identification and payment initiation process reduces the risk of fraudulent bills being paid. By presenting verified bill information directly from the accounting system, it becomes more difficult for unauthorized or fraudulent bills to be processed. Additionally, by integrating bill payments directly with the accounting software, the system 400 creates a clear audit trail, which can be particularly valuable for businesses that need to demonstrate compliance with financial regulations or undergo regular audits.

The reduction in manual data entry and streamlined payment process can lead to significant cost savings in terms of labor and potential late payment fees. This is especially beneficial for businesses with high volumes of bills to process. With a more efficient bill management system, businesses can have a clearer picture of their upcoming expenses, leading to more accurate financial forecasting and budgeting.

The system 400 allows users to easily select and pay multiple bills simultaneously, giving them greater control over when payments are made. This can be particularly useful for managing cash flow or taking advantage of early payment discounts. By presenting all relevant bill information in an easily accessible format, the system 400 reduces the risk of overlooking or forgetting to pay important bills, which can help avoid late fees and maintain good standing with vendors.

The ability to quickly access and review bill details directly from the accounting software's web interface enables users to make more informed decisions about which bills to pay and when, potentially optimizing the use of available funds. For businesses with multiple approvers for bill payments, the system 400's integrated approach can simplify and speed up the approval process, reducing delays in payment processing.

Embodiments of the present invention address several technical problems by providing technical solutions that result in tangible technical effects. Some of these technical problems and their technical solutions and technical effects include the following.

Embodiments of the present invention present a solution to the technical problem of inefficient invoice management by introducing a web browser plugin that automates the extraction of invoice information directly from a web page (e.g., a URL or a user interface element). This technical solution significantly reduces the time needed to locate and process invoices, thereby enhancing the overall efficiency of invoice management workflows. The automation provided by the plugin represents a technical effect that includes automatically extracting the additional invoice information from the accounting data, leading to a more efficient invoice management and payment process.

Embodiments of the present invention addresses the problem of manual data entry errors by implementing a plugin that automatically identifies unique invoice identifiers and retrieves the corresponding information from the accounting system. This solution effectively eliminates the need for users to manually input data, which is a common source of errors in financial transactions and record-keeping. As a result of this automation, the risk of human error is significantly reduced, leading to enhanced accuracy in financial transactions and the maintenance of precise financial records. This technical effect not only improves the reliability of the data but also contributes to the integrity of the overall accounting process.

The technical problem of lack of real-time data synchronization in accounting systems is adeptly addressed by the invoice management module, which establishes real-time communication with the accounting system. Utilizing communication mechanisms such as the accounting software application API, the plugin updates the payment status of invoices instantaneously upon receipt of payment instructions. This solution's technical effect is the immediate synchronization of accounting records, which guarantees that financial data is consistently current and reliable. The enhancement in data reliability is a direct consequence of the plugin's ability to provide up-to-date transactional information, thereby solving a critical issue faced by many accounting systems.

Embodiments of the present invention tackle the technical problem of limited system compatibility, which hampers the widespread adoption of accounting tools, by being designed to interface seamlessly with a diverse range of accounting systems and to maintain compatibility with various web browsers. The technical solution lies in the versatile design of the plugin, which is crafted to function across different software environments. The resulting technical effect of this approach is a broadened compatibility that significantly enhances the plugin's potential for widespread adoption and use. This cross-platform utility increases the invention's applicability and reach, ensuring that users can rely on the plugin regardless of their preferred accounting systems or web browsers.

Embodiments of the present invention introduce a technical solution to the problem of inefficient data management in accounting systems through an onboarding process that acquires and stores critical information, such as customer and invoice details, from the accounting system. This proactive approach to data management enables the plugin to operate using its own copies of the stored information, thereby diminishing the dependency on real-time data retrieval. The technical effect of this solution is a notable enhancement in the speed and efficiency of the plugin's functionality. By processing stored data instead of relying on live system queries, the plugin can offer faster response times and a more streamlined user experience, which is particularly beneficial in time-sensitive financial environments.

The technical solutions and the technical effects of those solutions described above demonstrate how embodiments of the present invention solve practical and technical problems in the field of accounting and financial management software, leading to improvements in efficiency, accuracy, and user experience.

One embodiment of the present invention is directed to a computer-implemented method for managing outstanding invoices in an accounting software application. The method includes: (a) analyzing a current web page displayed by a web browser to identify a unique invoice identifier; (b) obtaining, from the accounting software application, additional information about an invoice identified by the unique invoice identifier; (c) causing the web browser to display the additional information about the invoice; (d) receiving, from a user, an instruction to pay the invoice identified by the unique invoice identifier; and (e) in response to receiving the instruction to pay the invoice identified by the unique invoice identifier, causing the accounting software application to record a payment of the invoice identified by the unique invoice identifier.

In the method, (a) may include analyzing a URL of the current web page to identify the unique invoice identifier. In the method, (a) may include analyzing the URL of the current web page to identify the unique invoice identifier within the URL of the current web page based on a predetermined pattern associated with the accounting software application.

In the method, (a) may include analyzing a user interface element of the current web page to identify the unique invoice identifier. In the method, the user interface element may include a text field on the current web page.

In the method, (a), (b), (c), (d), and (e) may be performed by a plugin installed in the web browser.

In the method, the additional information may include at least one of customer details, invoice amount, invoice due date, and invoice payment status.

In the method, (b) may include making a request to the accounting software application via an Application Program Interface (API) and receiving the additional information via the API. In the method, the request may include the unique invoice identifier.

In the method, the current web page may be displayed by the web browser in a first user interface element; and causing the web browser to display the additional information about the invoice may include causing the web browser to display the additional information about the invoice in a second user interface element that is distinct from the first user interface element. In the method 10, the first user interface element may include a first window, and wherein the second user interface element may include a second window.

In the method, the additional information about the invoice may include information about a payment method associated with a customer associated with the invoice; and causing the web browser to display the additional information about the invoice may include causing the web browser to display the information about the payment method associated with the customer associated with the invoice. The method may further include, before (d): (f) receiving, from the user, an instruction to modify the payment method associated with the customer associated with the invoice, thereby producing a modified payment method associated with the customer associated with the invoice; and (e) may include causing the accounting software application to process the payment of the invoice identified by the unique invoice identifier using the modified payment method.

In the method, (c) may include displaying a user interface element for initiating the payment of the invoice identified by the unique invoice identifier; and (d) may include receiving, from the user, a selection of the user interface element for initiating the payment of the invoice identified by the unique invoice identifier. In the method, the user interface element for initiating the payment of the invoice identified by the unique invoice identifier may include a button.

In the method, (e) may include providing a request to the accounting software application to record the payment of the invoice identified by the unique invoice identifier, and wherein the request may include the unique invoice identifier.

Another embodiment of the present invention is directed to a computer-implemented method for managing outstanding invoices in an accounting software application. The method includes: (a) analyzing a current web page displayed by a web browser to identify a unique customer identifier; (b) obtaining, from the accounting software application, additional information about a customer identified by the unique customer identifier, the additional information including information about a plurality of open invoices of the customer; (c) causing the web browser to display the additional information about the customer, including the additional information about the plurality of open invoices of the customer; (d) receiving, from a user, a selection of multiple invoices within the plurality of open invoices of the customer; (e) receiving, from the user, an instruction to pay the multiple invoices; and (f) in response to receiving the instruction to pay the multiple invoices, causing the accounting software application to record payments of the multiple invoices.

In the method, (a) may include analyzing a URL of the current web page to identify the unique customer identifier. In the method, (a) may include analyzing the URL of the current web page to identify the unique customer identifier within the URL of the current web page based on a predetermined pattern associated with the accounting software application.

In the method, (a) may include analyzing a user interface element of the current web page to identify the unique customer identifier. In the method, the user interface element may include a text field on the current web page.

In the method, (a), (b), (c), (d), (e), and (f) may be performed by a plugin installed in the web browser.
23. In the method, the additional information may include at least one of customer details, invoice amount, invoice due date, and invoice payment status of each of the plurality of open invoices of the customer.

In the method, (b) may include making a request to the accounting software application via an Application Program Interface (API) and receiving the additional information via the API. In the method, the request may include the unique customer identifier.

In the method, the current web page may be displayed by the web browser in a first user interface element; and causing the web browser to display the additional information about the customer may include causing the web browser to display the additional information about the customer in a second user interface element that is distinct from the first user interface element. In the method, the first user interface element may include a first window, and the second user interface element may include a second window.

In the method, the additional information about the customer may include information about a payment method associated with the customer; and causing the web browser to display the additional information about the customer may include causing the web browser to display the information about the payment method associated with the customer. The method may further include, before (e): (g) receiving, from the user, an instruction to modify the payment method associated with the customer, thereby producing a modified payment method associated with the customer; and (f) may include causing the accounting software application to record the payments of the multiple invoices using the modified payment method.

In the method, (c) may include displaying a user interface element for initiating the payments of the multiple invoices; and (f) may include receiving, from the user, a selection of the user interface element for initiating the payments of the multiple invoices. In the method, the user interface element for initiating the payments of the multiple invoices may include a button.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, the ability of embodiments of the present invention to perform pattern matching algorithms to identify unique invoice identifiers within a URL, and its subsequent interaction with an accounting system's API to process payments, are tasks that require the speed and computational capabilities of a computer system. Additionally, the plugin's real-time data synchronization, which updates the payment status of invoices immediately after payment instructions are received, is a complex process that involves instantaneous communication and data processing that cannot be replicated by human mental work or manual effort. These computer-implemented processes demonstrate that the invention constitutes more than a mere abstract idea, as they are grounded in specific technological processes that are inherently rooted in computer technology and which are beyond the scope of mental or manual execution.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A computer-implemented method for managing outstanding bills in an accounting software application, the method comprising:
(a) analyzing a web page to identify a unique bill identifier;
(b) obtaining, from the accounting software application, additional information about a bill identified by the unique bill identifier;
(c) causing a web browser to display the additional information about the bill;
(d) receiving, from a user, an instruction to pay the bill identified by the unique bill identifier; and
(e) in response to receiving the instruction to pay the bill identified by the unique invoice identifier, causing the accounting software application to initiate a payment of the bill identified by the unique bill identifier.

2. The method of claim 1, wherein the web page comprises a web page currently displayed by the web browser.

3. The method of claim 1, wherein the web page comprises an image of a web page previously displayed by the web browser.

4. The method of claim 1, wherein (a) comprises analyzing a user interface element of the current web page to identify the unique bill identifier.

5. The method of claim 1, wherein (a) comprises analyzing content of the web page to identify the unique bill identifier.

6. The method of claim 1, wherein (a) comprises analyzing an image of a rendering of the web page to identify the unique bill identifier.

7. The method of claim 1, wherein (a), (b), (c), (d), and (e) are performed by a plugin installed in the web browser.

8. The method of claim 1, further comprising:
before (c), receiving input from the user in connection with a rendering of the unique bill identifier within a rendering of the web page; and
wherein (c) comprises causing the web browser to display the additional information about the bill in response to receiving the input from the user in connection with the rendering of the unique bill identifier.

9. The method of claim 1, further comprising:
before (c), receiving input from the user in connection with a rendering of the unique bill identifier within a rendering of the web page;
in response to receiving the input from the user in connection with the rendering of the unique bill identifier, displaying a menu comprising a plurality of menu items;
receiving, from the user, input selecting a payment triggering menu item within the plurality of menu items; and
wherein (c) comprises causing the web browser to display the additional information about the bill in response to receiving the input selecting the payment triggering menu item from the user.

10. The method of claim 1, wherein (b) comprises making a request to the accounting software application via an Application Program Interface (API) and receiving the additional information via the API.

11. A system comprising at least one non-transitory computer-readable medium having computer program instructions stored thereon, the computer program instructions being executable to perform a method for managing outstanding bills in an accounting software application, the method comprising:
(a) analyzing a current web page displayed by a web browser to identify a unique bill identifier;
(b) obtaining, from the accounting software application, additional information about an bill identified by the unique bill identifier;
(c) causing the web browser to display the additional information about the bill;
(d) receiving, from a user, an instruction to pay the bill identified by the unique bill identifier; and
(e) in response to receiving the instruction to pay the bill identified by the unique bill identifier, causing the accounting software application to initiate a payment of the bill identified by the unique bill identifier.

12. The system of claim 11, wherein the web page comprises a web page currently displayed by the web browser.

13. The system of claim 11, wherein the web page comprises an image of a web page previously displayed by the web browser.

14. The system of claim 11, wherein (a) comprises analyzing a user interface element of the current web page to identify the unique bill identifier.

15. The system of claim 11, wherein (a) comprises analyzing content of the web page to identify the unique bill identifier.

16. The system of claim 11, wherein (a) comprises analyzing an image of a rendering of the web page to identify the unique bill identifier.

17. The system of claim 11, wherein (a), (b), (c), (d), and (e) are performed by a plugin installed in the web browser.

18. The system of claim 11, wherein the method further comprises:
before (c), receiving input from the user in connection with a rendering of the unique bill identifier within a rendering of the web page; and
wherein (c) comprises causing the web browser to display the additional information about the bill in response to receiving the input from the user in connection with the rendering of the unique bill identifier.

19. The system of claim 11, wherein the method further comprises:
before (c), receiving input from the user in connection with a rendering of the unique bill identifier within a rendering of the web page;
in response to receiving the input from the user in connection with the rendering of the unique bill identifier, displaying a menu comprising a plurality of menu items;
receiving, from the user, input selecting a payment triggering menu item within the plurality of menu items; and
wherein (c) comprises causing the web browser to display the additional information about the bill in response to receiving the input selecting the payment triggering menu item from the user.

20. The system of claim 11, wherein (b) comprises making a request to the accounting software application via an Application Program Interface (API) and receiving the additional information via the API.
